(19) United States
(12) Patent Application Publication
(10) Pub. No.: US 2026/0361097 A1
(43) Pub. Date: Nov. 12, 2026

(54) MULTIPLE PACK CHARGING CONTROL FOR POWER TOOL BATTERY PACKS

(71) Applicant: Milwaukee Electric Tool Corporation, Brookfield, WI (US)

(72) Inventors: Anthony M. Davis, Brookfield, WI (US); Kevin Staszak, New Berlin, WI (US); John B. Lienau, Glendale, WI (US); Matthew J. Halenka, Milwaukee, WI (US); Joseph J. Walsh, Brookfield, WI (US); Steven M. Smith, Greenfield, WI (US); Omar Kurosu Jalil, Wauwatosa, WI (US)

(21) Appl. No.: 19/481,088

(22) PCT Filed: Mar. 13, 2024
(86) PCT No.: PCT/US2024/019718

§ 371 Date: Nov. 3, 2025

Related U.S. Application Data
(60) Provisional application No. 63/500,101, filed on May 4, 2023.

(51) Int. Cl. H02J 7/40; B25F 5/00; H02J 7/47; H02J 7/50; H02J 7/70

(52) U.S. Cl. CPC H02J 7/40; B25F 5/00; H02J 7/47; H02J 7/50; H02J 7/731

(57) ABSTRACT

Systems and methods are provided herein directed to charging coordination among multiple power tool battery chargers. Such coordination can increase the charging throughput of the chargers and reduce or maintain current draw below a threshold of a supplying power network. In some systems and methods, a charging coordination controller receives, wirelessly, charger information from a plurality of power tool battery charger systems, determines a charger subset based on the charger information, and transmits, wirelessly, a charger enabling instruction to the charger subset. In some systems and methods, power tool battery chargers are daisy-chained together, and each charger self-regulates charging based on a prioritization scheme to provide coordination among the chargers.

### RELATED APPLICATIONS

This application is based on, claims priority to, and incorporate herein by reference in their entirety U.S. Provisional Application Ser. No. 63/500,101, filed May 4, 2023.

### BACKGROUND

Power tools can be used for a variety of purposes such as cutting, drilling, driving, sanding, shaping, grinding, polishing, painting, heating, lighting, cleaning, gardening, hedge trimming, mowing, and construction, among other uses. Some power tools are cordless power tools that are powered by battery packs that are charged using a battery charger.

### SUMMARY

As additional types and varieties of cordless power tools become available, additional industries are changing over from equipment traditionally driven by gasoline-powered internal combustion engines to battery-powered motorized power tools. As cordless tools become more ubiquitous, effectively and efficiently charging power tool batteries becomes more challenging. In certain industries, for example, the lawn care industry, power tools (e.g., used for lawn care) may deplete multiple battery packs in a single workday. To be prepared for the next workday, a lawn care contractor with a fleet of lawn care power tools and corresponding battery packs may desire to charge each of the battery packs overnight. However, a local power network or circuit may not have sufficient current available to simultaneously power enough chargers such that each depleted battery pack can be charged in parallel. Accordingly, a user may limit the number of chargers plugged in to an AC power source and, thus, only a fraction of the depleted battery packs may be charged at a given time. Accordingly, the full fleet of battery packs may not be fully charged and available the next morning, or a user may manually intervene to swap battery packs to complete additional charging.

Some embodiments of the disclosure provide a system for charging power tool battery packs. The system includes a charger coordination controller including an electronic processor and a wireless transceiver. The charger coordination controller is configured to receive, via the wireless transceiver, charger information from a plurality of power tool battery charger systems; determine a charger subset of the plurality of power tool battery charger systems to be enabled based on the charger information, the charger subset including at least a first power tool battery charger system of the power tool battery charger systems; and transmit, via the wireless transceiver, a charger enabling instruction to the charger subset.

Some embodiments of the disclosure provide a method of charging power tool battery packs. The method includes receiving, by an electronic processor via a wireless transceiver, charger information from a plurality of power tool battery charger systems; determining, by the electronic processor, a charger subset of the plurality of power tool battery charger systems to be enabled based on the charger information, the charger subset including at least a first power tool battery charger system of the power tool battery charger systems; and transmitting, by the electronic processor via the wireless transceiver, a charger enabling instruction to the charger subset.

Some embodiments of the disclosure provide a system for charging power tool battery packs. The system includes a first power tool battery charger including: a battery pack interface configured to dock a power tool battery pack, a current sensor, a power input configured to receive input power, a daisy chain outlet configured to receive a charger plug of a second power tool battery charger, and a charger controller including an electronic processor and a memory. The charger controller is configured to: sense, via the current sensor, current at the daisy chain outlet of the power tool battery charger; in response to determining that the current at the daisy chain outlet is above a delay current threshold, delay charging of the power tool battery docked on the power tool battery charger; and in response to determining that the current at the daisy chain outlet is below a charging current threshold, initiate charging of the power tool battery docked on the power tool battery charger.

Some embodiments of the disclosure provide a method of charging power tool battery packs. The method includes receiving input power at a power input of a power tool battery charger; sensing, by a charger controller via a current sensor, current at a daisy chain outlet of the power tool battery charger; in response to determining that the current at the daisy chain outlet is above a delay current threshold, delaying, by the charger controller, charging of a power tool battery docked on the power tool battery charger; and in response to determining that the current at the daisy chain outlet is below a charging current threshold, initiating, by the charger controller, charging of the power tool battery docked on the power tool battery charger.

Some embodiments of the disclosure provide a system for charging power tool battery packs. The system includes a first power tool battery charger including: a battery pack interface configured to dock a power tool battery pack, a power input configured to receive input power, a daisy chain outlet configured to receive a charger plug of a second power tool battery charger, and a switch electrically between the power input and the daisy chain outlet, a charger controller including an electronic processor and a memory. The charger controller is configured to: control the switch to disconnect the power input from the daisy chain outlet; charge the power tool battery docked on the power tool battery charger; and in response to a charge level of the power tool battery being above a threshold, control the switch to connect the power input to the daisy chain outlet to supply output power at the daisy chain outlet.

Some embodiments of the disclosure provide a method of charging power tool battery packs. The method includes: receiving input power at a power input of a power tool battery charger; controlling, by a charger controller, a switch of the power tool battery charger to disconnect the power input from a daisy chain outlet of the power tool battery charger; charging, by the power tool battery charger, a power tool battery docked on the power tool battery charger; and in response to a charge level of the power tool battery being above a threshold, controlling, by the charger controller, the switch of the power tool battery charger to connect the power input to the daisy chain outlet of the power tool battery charger to supply output power at the daisy chain outlet.

Additional embodiments and examples are provided herein.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 illustrates a charging system for charging power tool battery packs according to some examples.

FIG. 2B illustrates an example of the charging system of FIG. 1A.

FIG. 2C illustrates another example of the charging system of FIG. 1A.

FIGS. 3A, 3B, and 3C illustrate respective examples of a charger coordination controller according to some examples.

FIG. 4A illustrates an example of the charging system of FIG. 1A communicating via a mesh network.

FIG. 4B illustrates an example of the charging system of FIG. 1A communicating via a star network.

FIG. 5 is a block diagram of a power tool battery charger according to some examples.

FIG. 6 is a block diagram of a charger coordination controller according to some examples.

FIG. 7 is a block diagram of a power tool battery pack according to some examples.

FIG. 8 is a block diagram of a wireless outlet controller according to some examples.

FIG. 9A is a flowchart illustrating a method of charging power tool battery packs according to some examples.

FIGS. 9B-E are additional flowcharts illustrating a method of charging power tool battery packs according to some examples.

FIG. 10A illustrates another charging system for charging power tool battery packs according to some examples.

FIG. 10B illustrates another charging system for charging power tool battery packs according to some examples.

FIG. 10C-10D illustrate another charging system for charging power tool battery packs according to some examples.

FIG. 11 is a block diagram of a power tool battery charger that may be included the charging system of FIGS. 10A, 10B, or 10C-10D, according to some examples.

FIG. 12 a flowchart illustrating a process of charging power tool battery packs that prioritizes downstream battery chargers according to some examples.

FIG. 13 is a block diagram of another power tool battery charger that may be included the charging system of FIGS. 10A, 10B, or 10C-10D, according to some examples.

FIG. 14 a flowchart illustrating a process of charging power tool battery packs that prioritizes upstream battery chargers according to some examples.

### DETAILED DESCRIPTION

As additional types and varieties of cordless power tools become available, additional industries are changing over from equipment traditionally driven by gasoline-powered internal combustion engines to battery-powered motorized power tools. As cordless tools become more ubiquitous, effectively and efficiently charging power tool batteries becomes more challenging. In certain industries, for example, the lawn care industry, power tools (e.g., used for lawn care) may deplete multiple battery packs in a single workday. To be prepared for the next workday, a lawn care contractor with a fleet of lawn care power tools and corresponding battery packs may desire to charge each of the battery packs overnight. However, a local power network or circuit may not have sufficient current available to simultaneously power enough chargers such that each depleted battery pack can be charged in parallel. Accordingly, a user may limit the number of chargers plugged in to an AC power source and, thus, only a fraction of the depleted battery packs may be charged at a given time. Accordingly, the full fleet of battery packs, which may include 10, 20, 30, 40, 50, or more battery packs, may not be fully charged and available the next morning, or a user may manually intervene to swap battery packs to complete additional charging.

Some embodiments and examples described herein provide multiple battery pack charging control. The multiple battery pack charging control may include coordination among multiple battery chargers, for example, to increase the charging throughput of the chargers, thereby increasing the number of battery packs charged in a given time period, to increase the efficiency of battery charging, among other benefits. Such coordinated control can also reduce current draw or maintain current draw below certain thresholds to reduce or eliminate activation of circuit breakers. Accordingly, at least in some examples, a user can couple a fleet of depleted battery packs to corresponding battery chargers for charging at the end of a shift or day, and return to a fully or sufficiently charged fleet of battery packs (e.g., to start a next shift or day of work) without user intervention during the course of charging and without exceeding a current limit of a supplying power network (e.g., without a “tripped” circuit breaker or blown fuse).

In some systems and methods, a charging coordination controller (whether as a separate device or integrated into a power tool battery charger) receives, wirelessly, charger information from a plurality of power tool battery charger systems, determines a charger subset based on the charger information, and transmits, wirelessly, a charger enabling instruction to the charger subset. In some systems and methods, power tool battery chargers are daisy-chained together, and each charger self-regulates charging based on a prioritization scheme to provide coordination among the chargers.

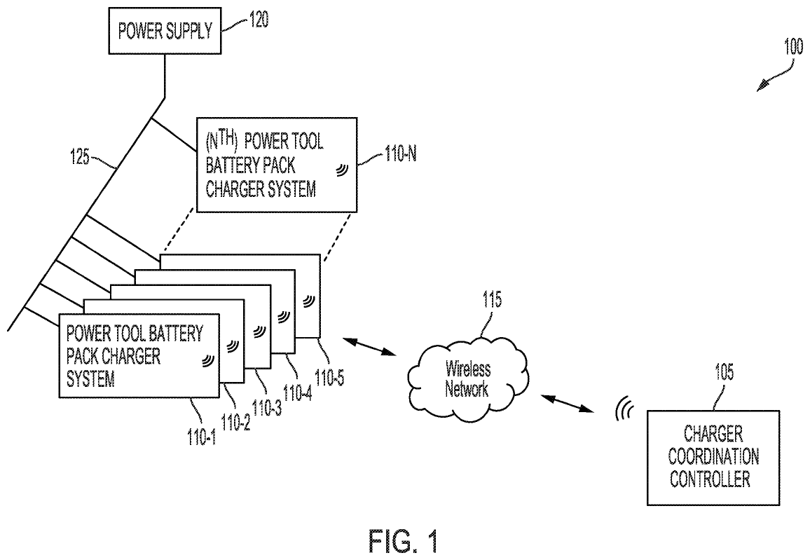

FIG. 1 illustrates a charging system 100 for charging power tool battery packs according to some examples. The charging system 100 includes a charger coordination controller 105, a plurality of power tool battery pack charger systems 110-1 to 110-N (herein, charger systems 110), a wireless communication network 115, and a power supply 120. A charger system of the charger systems 110 may be referred to generically as a charger system 110 or collectively as the charger systems 110. The power supply may be a power grid, such as a local grid or utility grid, or a node thereof (e.g., a connection point to the power grid). The power supply 120 may supply power (e.g., alternating current (AC) power) to the charger systems 110 via power network 125. The charger systems 110 may receive the power from the power supply 120 and apply the power to power tool battery packs (not shown in FIG. 1) to charge the power tool battery packs.

The charger coordination controller 105 may communicate with the charger systems 110 via the wireless communication network 115 to receive charger information from the charger systems 110 and to provide charging instructions to the charger systems 110 to control charging of power tool battery packs by the charger systems 110. In some examples, the wireless communication network 115 includes direct peer-to-peer communication links between each respective charger system 110 and the charger coordination controller 105. In other examples, the wireless network 115 includes a mesh network, for example, made up of the charger systems 110 and the charger coordination controller 105. The wireless communications between the charger coordination controller 105 and the charger systems may use one or more various wireless communication protocols, for example, Bluetooth, Wi-Fi, Zigbee, ultrawide band (UWB), or the like. Although shown separately, in some examples, the charger coordination controller 105 is integrated into a battery charger of a charger system 110. In other examples, the charger coordination controller 105 is a standalone device in a separate housing and not integrated into a battery charger. In some examples, the charging system 100 includes additional or fewer components than illustrated in FIG. 1.

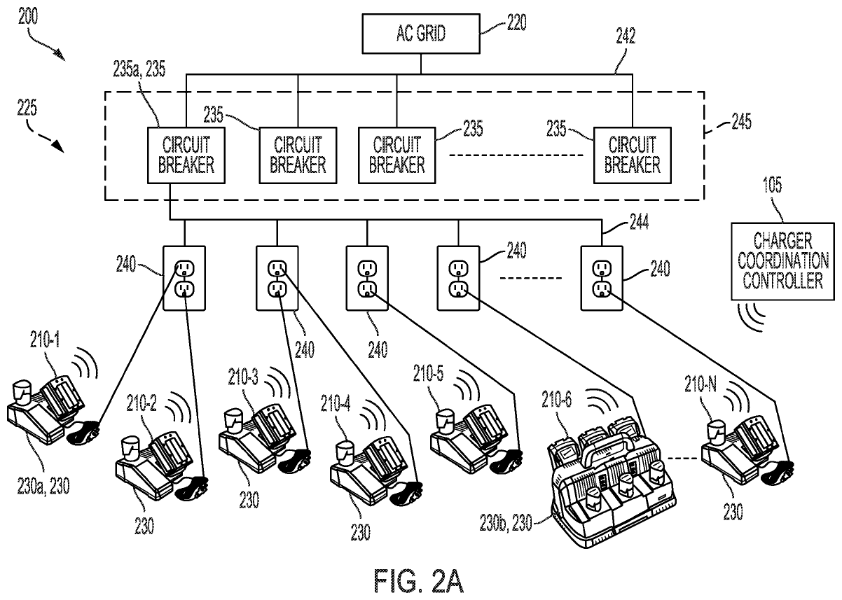

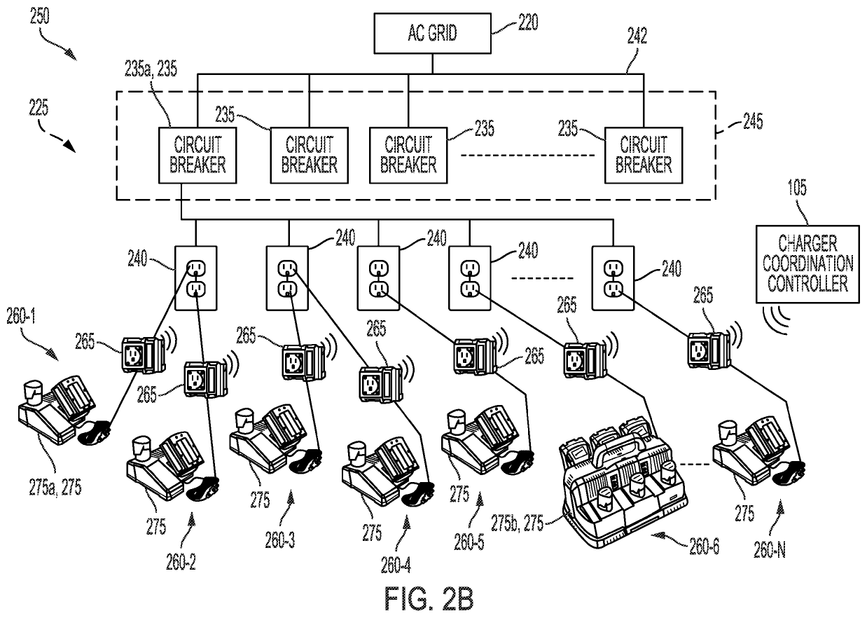

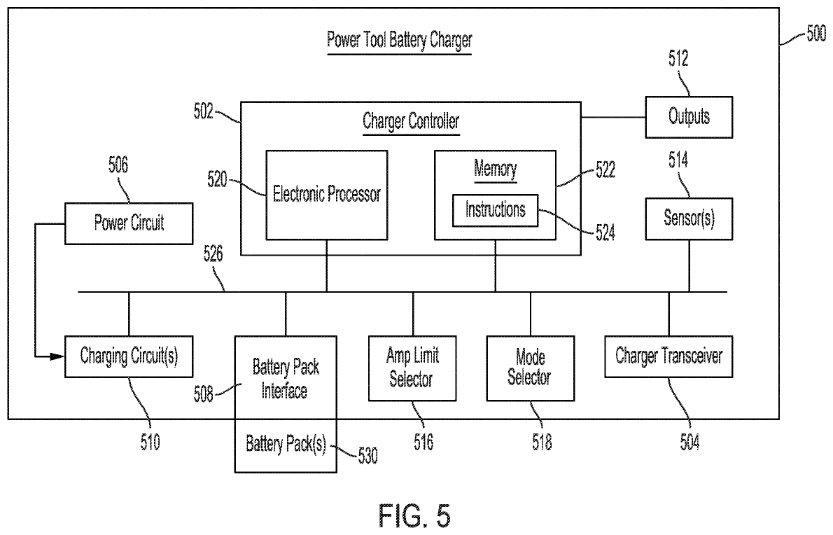

FIGS. 2A and 2B illustrate examples of the charging system 100 in further detail. More particularly, FIG. 2A illustrates charging system 200, which is example of the charging system 100 of FIG. 1. The charging system 200 includes the charger coordination controller 105, power tool battery charger systems 210-1 to 210-N (herein, charger systems 210), a power supply 220, and a power network 225. A charger system of the charger systems 210 may be referred to generically as a charger system 210 or collectively as the charger systems 210. The power tool battery charger systems 210-1 to 210-N each include a battery charger 230 (e.g., battery charger 230a or 230b) with an integrated wireless transceiver (see, e.g., charger transceiver 504 of FIG. 5). In the system 200, each battery charger 230 is configured to wirelessly communicate with the charger coordination controller 105 (e.g., via a wireless network similar to wireless network 115 of FIG. 1). Accordingly, the charger coordination controller 105 may wirelessly communicate with the charger systems 210 to receive charger information from the charger systems 210 and to provide charging instructions to the charger systems 210 to control and coordinate charging of power tool battery packs by the charger systems 210.

The battery charger 230a is a combo-charger operable to receive and charge two types of battery packs, each having a respective formfactor and nominal voltage. For example, battery charger 230a is operable to receive and charge a stem-style pack having a first nominal volage (e.g., 12 volts, or between 10-14 volts), and a slide-on style pack having a second (larger) nominal voltage (e.g., 18 volts, or between 16-24 volts). The battery charger 230b is operable to receive and charge three battery packs of a first type (e.g., which may be similar to the aforementioned stem-style pack) and three battery packs of a second type (e.g., which may be similar to the aforementioned slide-on style pack). In other examples, the charger systems 210 include different types of battery chargers than illustrated and/or different combinations of battery chargers than illustrated. For example, the battery chargers may include single-pack chargers (e.g., for charging the first type or second type of battery pack), multi-pack, single-type chargers (e.g., for charging multiple of the first type or multiple of the second type of battery pack), and/or chargers for charging other types of power tool battery packs than those shown (e.g., packs with nominal voltages above 24 volts, such as packs with nominal voltages between 24 and 120 volts).

The power supply 220 is an example of the power supply 120 of FIG. 1 and the power network 225 is an example of the power network 125. The power supply 220 is also referred to as an alternating current (AC) grid 220, which may be a local grid, utility grid, or connection point thereto). The power network 225 includes circuit breakers 235, outlets 240, and power lines 242, 244. The power lines 242 connect the circuit breakers 235 to the AC grid 220, and the power lines 244 connect a first circuit breaker 235a of the circuit breakers 235 to the outlets 240. In some examples, the circuit breakers 235 may be organized and supported in a housing or panel 245. The circuit breakers 235 may be configured to make and break an electrical connection between power lines 242 and corresponding power lines and outlets downstream of the circuit breakers 235. For example, the circuit breaker 235a is configured to make and break an electrical connection between the power lines 242 and the power lines 244 (and, thus, between AC grid 220 and the outlets 240). The circuit breakers 235 may be associated with a current rating or threshold at which the circuit breaker 235 will automatically open or break the connection between upstream power (e.g., AC grid 220) and downstream power lines and outlets (e.g., power lines 244 and outlets 240). For example, the circuit breakers 235 may be 15 ampere (A) breakers, 20 ampere (A) breakers, or breakers of another rating. For example, in the case of the circuit breaker 235a being a 15 A breaker, the circuit breaker 235 is configured to open (or “break”) when current drawn through the circuit breaker 235a (e.g., by a downstream load, such as a battery charger, lights, other equipment) exceeds 15 A. Similarly, in the case of the circuit breaker 235a being a 20 A breaker, the circuit breaker 235 is configured to open (or “break”) when current drawn through the circuit breaker 235a (e.g., by a downstream load, such as a battery charger, lights, other equipment) exceeds 20 A.

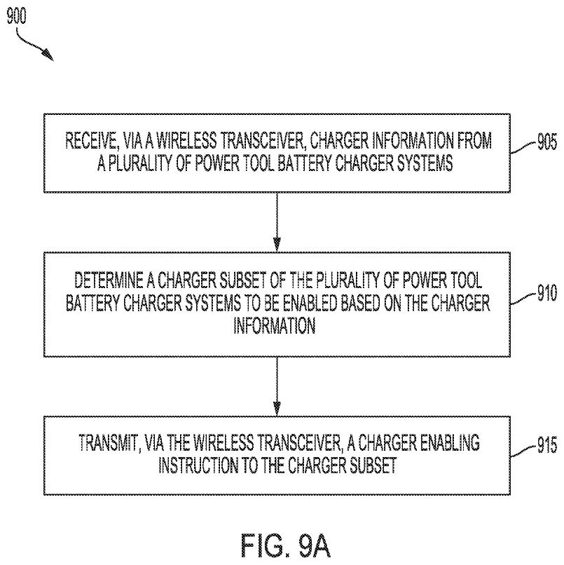

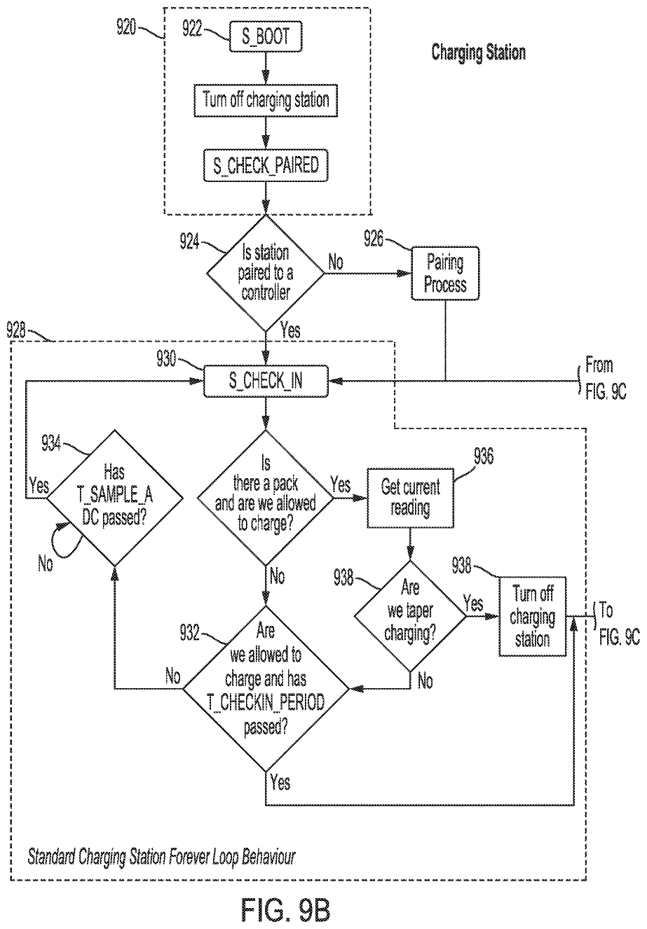

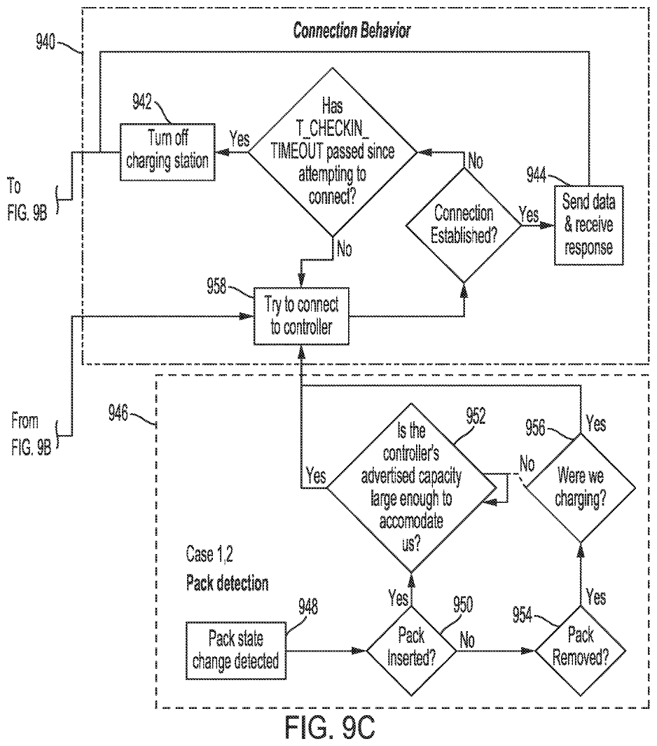

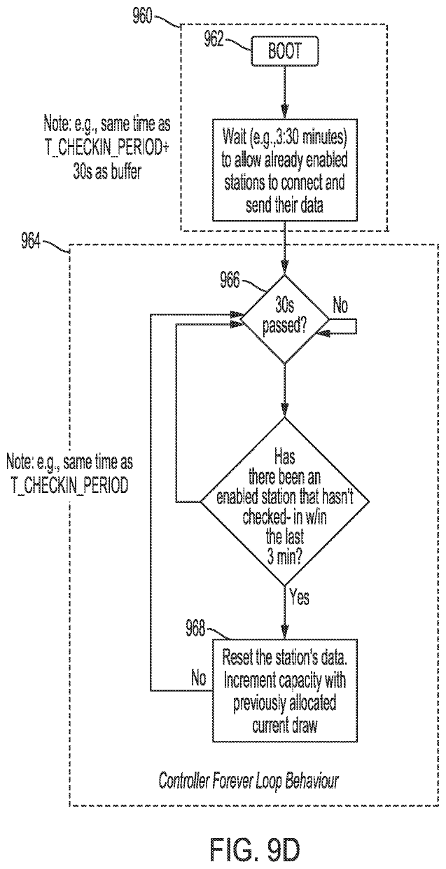

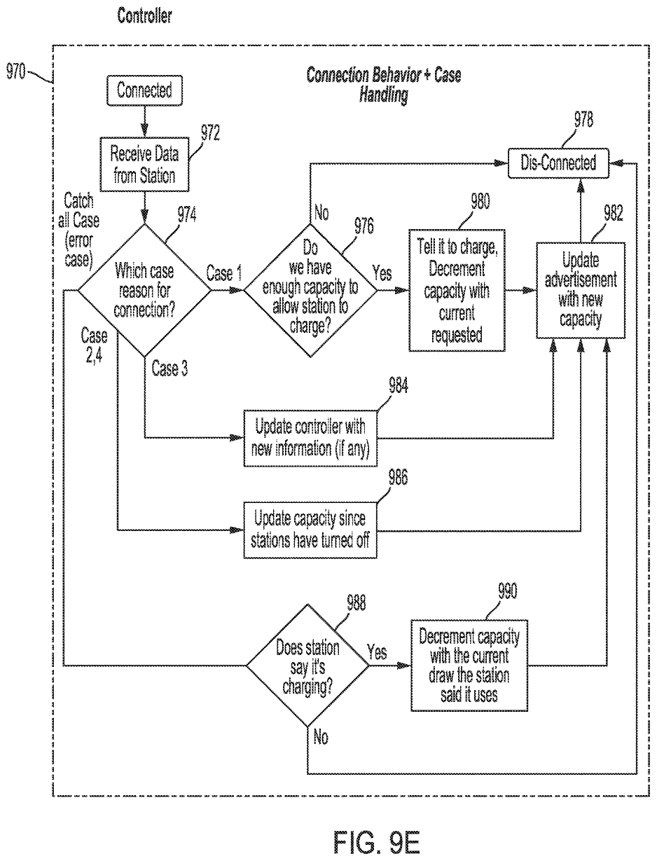

Although not illustrated in FIG. 2A, in some examples, one or more further circuit breakers 235 are coupled to their own respective set of outlets 240, and each respective set of outlets may have a further set of a plurality of battery charger systems 210-1 to 210-N and corresponding charger coordination controller 105 for coordinating charging by the associated set of battery charger systems 210-1 to 210-N. For example, each charger coordination controller 105 may implement the process 900 of FIG. 9A, described further below. In some examples, one charger coordination controller 105 may coordinate charging of two or more different sets of plurality of charger systems 210 as distinct groups, as each set is coupled to a different circuit breaker 235 with a separate current threshold.

FIG. 2B illustrates charging system 250, which is example of the charging system 100 of FIG. 1. The charging system 250 includes the charger coordination controller 105, power tool battery charger systems 260-1 to 260-N (herein, charger systems 260), the power supply 220, and the power network 225. A charger system of the charger systems 260 may be referred to generically as a charger system 260 or collectively as the charger systems 260. The charging system 250 is generally similar to the charging system 200 and the discussion above with respect to the charging system 200 and like numbered components similarly applies to the charging system 250, except for differences noted herein. In particular, in contrast to the charging system 200, the charging system 250 includes power tool battery pack charger system 260-1 to 260-N. Rather than having integrated wireless transceivers integrated into a battery charger, the charger systems 260-1 to 260-N each include a respective wireless outlet controller 265 connected via a power cord 270 to a battery charger 275 (e.g., a battery charger 275a or 275b).

In the system 200, each wireless outlet controller 265 is configured to wirelessly communicate with the charger coordination controller 105 (e.g., via a wireless network similar to wireless network 115 of FIG. 1). Additionally, each wireless outlet controller 265 of a charger system 260 is configured to enable or disable the flow of power received from a respective outlet 240, through the wireless outlet controller 265, to the corresponding battery charger 275 of the charger system 260. Accordingly, in the charging system 250, the charger coordination controller 105 may wirelessly communicate with the charger systems 260 to receive charger information from the charger systems 260 and to provide charging instructions to the charger systems 260 to control and coordinate charging of power tool battery packs by the charger systems 260.

In some examples, a charging system is provided, similar to the charging systems 200 and 250, but which includes a combination of charger systems 210 and charger systems 260 coupled to the outlets 240 and in communication with the charger coordination controller 105.

Although not illustrated in FIG. 2B, in some examples, one or more further circuit breakers 235 are coupled to their own respective set of outlets 240, and each respective set of outlets may have a further set of a plurality of battery charger systems 260-1 to 260-N and corresponding charger coordination controller 105 for coordinating charging by the associated set of battery charger systems 260-1 to 260-N. For example, each charger coordination controller 105 may implement the process 900 of FIG. 9A, described further below. In some examples, one charger coordination controller 105 may coordinate charging of two or more different sets of plurality of battery charger systems 260 as distinct groups, as each set is coupled to a different circuit breaker 235 with a separate current threshold.

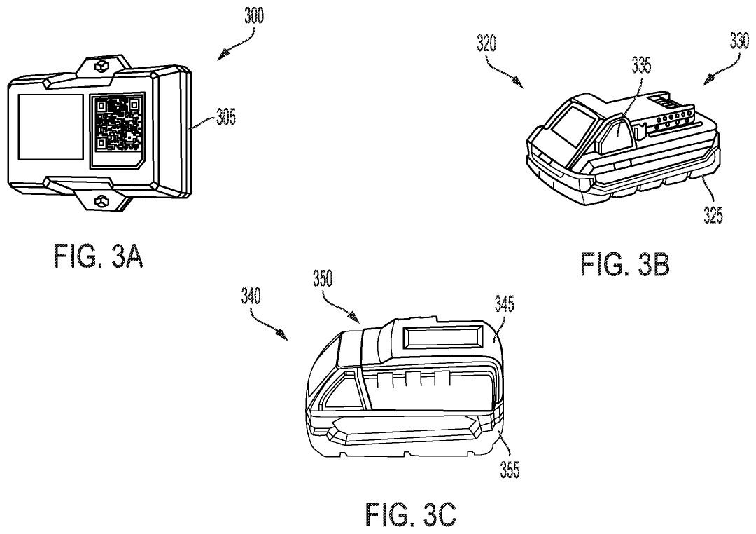

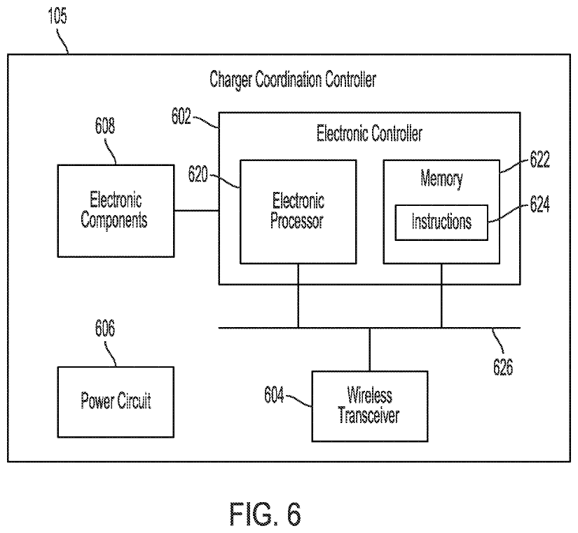

FIGS. 3A, 3B, and 3C illustrate respective examples of the charger coordination controller 105. More particularly, FIG. 3A illustrates a charger coordination controller 300, FIG. 3B illustrates a charger coordination controller 320, and FIG. 3C illustrates a charger coordination controller 340. Each of the charger coordination controllers 300, 320, and 340 are examples of the charger coordination controller 105 illustrated in FIGS. 1, 2A, and 2B. The charger coordination controller 300 includes a controller housing 305. In some examples, the charger coordination controller 300 includes an internal power source (e.g., coin cell or other battery cell(s)) along with other circuitry and components, for example, as illustrated in the block diagram of FIG. 6. The internal power source may provide power for the other circuitry and components, including an electronic processor and wireless transceiver of the controller 300.

The charger coordination controller 320 has the form factor of a power tool battery pack, including a controller housing 325, and electro-mechanical interface 330, and latch release buttons 335. The electro-mechanical interface 330 includes rails to slidingly engage corresponding rails of a battery charger, and electrical terminals to electrically couple to corresponding terminals of the battery charger. The charger coordination controller 320 is configured, via the electro-mechanical interface 330, to engage with a power tool battery charger to receive power. In other examples, the charger coordination controller 320 has the form factor of a power tool battery pack with a stem-style interface, rather than a slide-on interface.

The charger coordination controller 340 has the including a controller housing 345 and electro-mechanical interface 350. The electro-mechanical interrace 330 has the form factor of a battery interface of a power tool or charger to engage with a power tool battery pack 355. The electro-mechanical interface 350 is configured to includes rails to slidingly engage corresponding rails of the battery pack 355, and electrical terminals to electrically couple to corresponding terminals of the battery pack 355. The charger coordination controller 340 is configured, via the electro-mechanical interface 350, to engage with the power tool battery pack 355 to receive power. In other examples, the charger coordination controller 340 has the form factor of a battery interface for receiving a stem-style battery pack, rather than a slide-on battery pack.

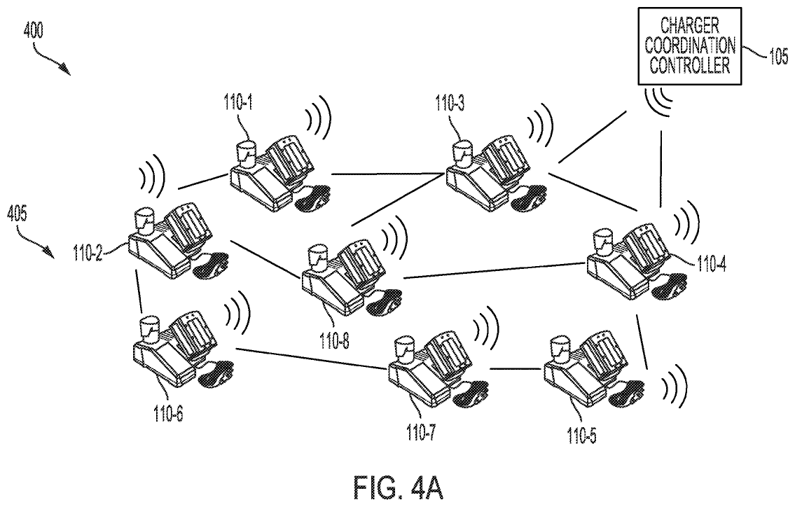

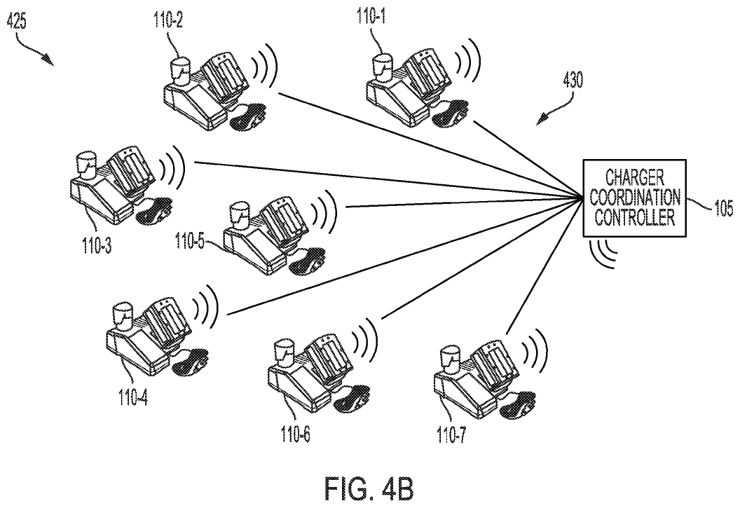

FIG. 4A illustrates a charging system 400 implementing a mesh network 405. The charging system 400 is an example of the charging system 100 and includes the charger coordination controller 105 and charger systems 110-1 to 110-8. The mesh network 405 is an example of the wireless network 115 of FIG. 1. The charger coordination controller 105 and the charger systems 110-1 to 110-8 may communicate with one another via the mesh network 405. Accordingly, one charger system 110 (e.g., charger system 110-1) may communicate with the charger coordination controller 105 directly or via intervening charger systems 110 (e.g., charger system 110-3).

FIG. 4 illustrates a charging system 425 implementing a star network 430. The charging system 425 is an example of the charging system 100 and includes the charger coordination controller 105 and charger systems 110-1 to 110-7. The star network 430 is an example of the wireless network 115 of FIG. 1. The charger coordination controller 105 and the charger systems 110-1 to 110-7 may communicate with one another via the star network 430. Accordingly, each charger system 110 may communicate with the charger coordination controller 105 directly, rather than via intervening charger systems 110.

Although the charging systems 400 and 425 of FIGS. 4A and 4B are illustrated as including battery chargers with integrated wireless transceivers (e.g., similar to battery chargers 230 of charger systems 210 in FIG. 2A), in some examples, a portion or all of the charging systems 400 and 425 may include charger systems with wireless outlet controllers (e.g., similar to charger systems 260 in FIG. 2B).

FIG. 5 is a block diagram of a power tool battery charger 500, according to some examples. The power tool battery charger 500 (also referred to as the battery charger 500) is an example of a battery charger included in a charger system 110, 210, 260 described above with respect to FIGS. 1, 2A, and 2B. In some examples, the battery charger 500 is an example of the battery charger 230 or 275.

As shown in FIG. 5, the battery charger 500 includes an electronic controller 502, also referred to as charger controller 502, a wireless transceiver 504, also referred to as a charger transceiver 504, a power circuit 506, a battery pack interface 508, one or more charging circuits 510, outputs 512, one or more sensors 514, an amp limit selector 516, and a charging mode selector 518, etc.

The charger controller 502 can include an electronic processor 520 and memory 522. The electronic processor 520, the memory 522, and the wireless transceiver 504 can communicate over one or more control buses, data buses, etc., which can include a device communication bus 526.

The electronic processor 520, also referred to as the charger processor 520, can be configured to communicate with the memory 522 to store data and retrieve stored data. The electronic processor 520 can be configured to receive instructions and data from the memory 522 and execute, among other things, the instructions. In particular, the electronic processor 520 executes instructions stored in the memory 522. Thus, the charger controller 502 coupled with the electronic processor 520 and the memory 522 can be configured to perform or control the functions of the battery charger 500 described herein, including control charging of battery packs and communication with the charger coordination controller 105.

The memory 522, also referred to as the charger memory 522, can include read-only memory (“ROM”), random access memory (“RAM”), other non-transitory computer-readable media, or a combination thereof. The memory 522 can include instructions 524 for the electronic processor 520 to execute. The instructions 524 can include software executable by the electronic processor 520 to enable the charger controller 502 to, among other things, perform or control the functions of the battery charger 500 described herein, including control charging of battery packs and communication with the charger coordination controller 105. The software can include, for example, firmware, one or more applications, program data, filters, rules, one or more program modules, and other executable instructions.

The electronic processor 520 is configured to retrieve from memory 522 and execute, among other things, instructions related to the control processes and methods described herein. The electronic processor 520 is also configured to store data on, and retrieve data from, the memory 522 including charger information and/or battery information. The charger information may include, for example, one or more of: a charger identifier, a battery pack identifier, a charger ready indication, a battery pack docked indication, expected current draw based on a docked battery pack, present current draw of the charger, charger settings, or the like.

A charger identifier may be a unique identifier for a particular instance of the charger 500 (e.g., a serial number), an identifier of a model type of the charger 500, other charger characteristics of the charger 500 (e.g., number of battery pack receptacles, types of battery pack receptacles, etc.) that indicates a type of the charger 500, or a combination thereof.

A battery pack identifier may be a unique identifier for a particular instance of a battery pack presently engaged with the battery pack interface 508 (e.g., a serial number), an identifier of a model type of a battery pack presently engaged with the battery pack interface 508, other battery pack characteristics (e.g., nominal voltage, amp-hours rating, etc.) that indicate a type of the charger 500, or a combination thereof.

A charger ready indication may indicate that one or more battery packs 530 are coupled to the battery pack interface 508 and is not fully charged (or otherwise available to accept charging current) and that the charger 500 is ready to charge one or more of the battery packs 530.

A battery pack docked indication may indicate that one or more battery packs 530 are coupled to the battery pack interface 508 of the charger 500.

Expected current draw based on a docked battery pack may indicate an expected current level (e.g., in Amperes) that the charger controller 502 estimates will be drawn by the charger 500 (e.g., the charging circuits 510) to charge one or more battery packs 530 coupled to the battery pack interface 508 if the charger 500 begins charging. The charger controller 502 may estimate the expected current draw based on the number, type, and/or charge level (state of charge) of the one or more battery packs 530. The charger controller 502 may estimate the charge level of a battery pack 530 based on a voltage measurement received via a voltage sensor of the sensors 514.

Present current draw of the charger may indicate a measured or estimated current drawn by the charger 500 at a particular time (e.g., instantaneous or average current value). The charger controller 502 may determine the present current draw via a current sensor of the sensors 514, where the current sensor is configured to measure current being drawn by the charger 500. For example, the current sensor may be configured to measure current received via power circuit 506 or being output by charging circuits 510.

Charger settings may include, among other things, a power circuit amperage limit, a charging mode, or a combination thereof. The power circuit amperage may indicate an amperage limit of a power circuit to which the charger 500 is coupled. For example, with reference to FIGS. 2A and 2B, the power circuit amperage limit may refer to the current threshold or limit of a circuit breaker to which the charger is coupled. In some examples, the power circuit amperage limit may be selected as either 15 A or 20 A. In some examples, the amp limit selector 516 is configured to receive a user selection of the amp limit and to indicate to the charger controller 502 the selected amp limit. The amp limit selector 516 may be, for example, a dip switch, a push button, a dial, a soft key, or other user-manipulatable selector.

The charging mode may indicate whether the charger 500 is in a standalone charging mode or a coordinated charging mode. In the standalone charging mode, the charger 500 may operate to charge one or more battery packs independent of wireless communications from an external device, such as the charger coordination controller 105. In other words, in the standalone charging mode, the charging performed by the charger 500 is not coordinated with other chargers. In the coordinated charging mode, the charger 500 is configured to perform charging of one or more battery packs in coordination with other chargers, such as described herein (see, e.g., FIG. 9A). In some examples, the charging mode selector 518 is configured to receive a user selection of the charging mode and to indicate to the charger controller 502 the selected charging mode. The charging mode selector 518, may be, for example, a dip switch, a push button, a dial, a soft key, or other user-manipulatable selector.

The battery information may include, for example, data transmitted by one or more battery packs 530 coupled to the battery pack interface 508 to the charger 500. The battery information may include, for example, usage data, number of charging cycles, battery temperature, battery pack geographic location, a battery pack identifier (e.g., serial number), battery pack owner identifier, charge time, state of charge of the battery (initially, at end of charging cycle, and/or periodically during the charging cycle), state of health of the battery, state of charge or the like.

The wireless transceiver 504 is coupled to the charger controller 502 (e.g., via a device communication bus 526). The wireless transceiver 504 may include, for example, a radio transceiver and antenna, a memory, and an electronic processor. The radio transceiver and antenna operate together to enable the charger 500 (e.g., the charger processor 520) to send and receive wireless messages to and from, for example, the charger coordination controller 105, one or more additional power tool battery chargers, a mobile device (e.g., a smart phone), laptop, tablet, and/or another wireless computing device.

In some examples, the wireless transceiver 504 is a Bluetooth® controller that enables wireless communications via the Bluetooth® protocol. In other examples, the wireless transceiver 504 communicates using other protocols (e.g., Wi-Fi, cellular protocols, a proprietary protocol, etc.). For example, the wireless transceiver 504 may be configured to communicate via Wi-Fi through a wide area network such as the Internet or a local area network, or to communicate through a piconet (e.g., using infrared or NFC communications). The communication via the wireless transceiver 504 may be encrypted to protect the data exchanged between the power tool battery charger 500 and other devices.

In some examples, the power circuit 506 can include an AC plug (e.g., configured to connect to conventional AC wall outlet), a DC plug configured to connect to a DC outlet, and/or power conditioning circuitry (e.g., a filter, transformer, etc.). One or more characteristics of the power circuit 506 can be monitored by one or more of the sensors 514 of the power tool battery charger 500. For example, a voltage of the power circuit 506 can be monitored by a sensor 514 implemented as a voltage sensor, which can generate output as power source data that indicate a voltage measured, detected, or otherwise monitored on the power circuit 506; or a current of the power circuit 506 can be monitored by a sensor 514 implemented as a current sensor, which can generate output as power source data that indicate a current measured, detected, or otherwise monitored on the power circuit 506.

The power tool battery charger 500 also includes a power tool battery pack interface 508 that is configured to selectively receive and interface with one or more power tool battery packs 530 (e.g., one or more of the battery packs illustrated in FIGS. 2A, 2B, 4A, or 4B). The power tool battery pack interface 508 may include one or more charging ports (e.g., for engaging with and providing charging current to one or more battery packs). Each charging port (also referred to as a receptacle) of the battery pack interface 508 can include one or more power terminals and, in some cases, one or more communication terminals that interface with respective power terminals, communication terminals, etc., of the power tool battery pack(s) 530.

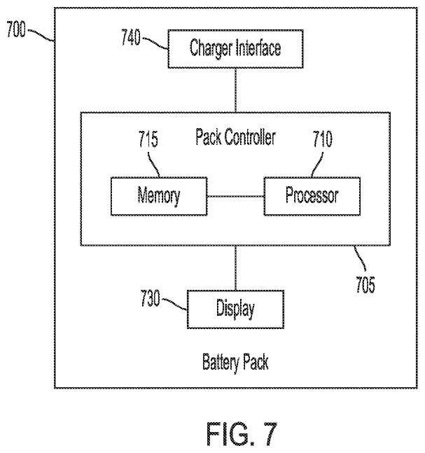

In some examples, the power tool battery pack interface 508 provides an electrical and mechanical connection for a battery pack 530. Additionally or alternatively, the power tool battery pack interface 508 can provide a wireless coupling to a battery pack 530 in order to provide wireless energy transfer from the power tool battery charger 500 to the battery pack 530. For example, in some configurations the power tool battery pack interface 508 may include one or more transmitter coils for charging a battery pack 530 using a wireless energy transfer (e.g., via electromagnetic induction). An example of the power tool battery pack(s) 530 is described with respect to FIG. 7 below.

The charger controller 502 controls the charging circuit(s) 510 to charge the battery pack(s) 530. For example, charging circuit(s) 510 can each include controllable power switching elements (e.g., field effect transistors, IGBTs, and the like) that the electronic processor 520 of the charger controller 502 selectively enables to provide power from the power circuit 506 to the respective battery pack(s) 530.

In some examples, the charger controller 502 is also connected to one or more sensors 514, which may include voltage sensors or voltage sensing circuits, current sensors or current sensing circuits, temperature sensors or temperature sensing circuits, inertial sensors or inertial sensing circuits (e.g., accelerometers, gyroscopes, magnetometers), or the like. The temperature sensor(s) may include, for example, a thermistor. Each temperature sensor sends a signal to the charger controller 502 indicating a temperature of the battery pack (e.g., indicative of a temperature of battery cells within the pack), a temperature of the battery charger 500 (e.g., indicative of a temperature within a housing of the charger, of power switching elements, and/or other electronics of the battery charger 500), and/or an ambient temperature of the environment around the battery charger 500.

In some embodiments, the power tool battery charger 500 may include one or more outputs 792 that are also coupled to the charger controller 502. The output(s) 792 can receive control signals from the charger controller 502 to generate a visual signal or audible signal to convey information regarding the operation or state of the power tool battery charger 500 to the user. The output(s) 792 may include, for example, LEDs or a display screen and may generate various signals indicative of, for example, an operational state or mode of the power tool battery charger 500, an abnormal condition or event detected during the operation of the power tool battery charger 500, and the like. For example, the output(s) 792 may indicate measured electrical characteristics of the power tool battery charger 500, the state or status of the power tool battery charger 500, an operating mode of the power tool battery charger 500, and the like.

In some examples, the charger 500 includes additional or fewer components than illustrated in FIG. 5, or components arranged in a different manner than illustrated. For example, in some examples, one or more of the amp limit selector 516, the mode selector 518, and/or the output(s) 512, is/are not included on the power tool battery charger 500.

In some examples, the charger transceiver 504 is not included in the charger 500. For example, with reference to FIG. 2B, a charger system 260 may include a charger 275 and a wireless outlet controller 265. In such examples, the charger 275 may be implemented as the charger 500 illustrated in FIG. 5, but without the charger transceiver 504. In contrast, as an example, a charger system 210 of FIG. 2A may include a charger 230, which may be implemented as the charger 5600 illustrated in FIG. 5 with the charger transceiver 504. In other words, the charger diagram in FIG. 5 is, in some examples, applicable to the charger 230 (as illustrated) and to the charger 275 (as illustrated, less the charger transceiver 504).

FIG. 6 is a block diagram of an example of the charger coordination controller 105, according to some examples. The charger coordination controller 105 illustrated in FIG. 6 is an example of the charger coordination controller 105 included in the charging systems 100, 200, 250, 400, 425 described above with respect to FIGS. 1, 2A, 2B, 4A, 4B, respectively. In some examples, the charger coordination controller 105 illustrated in FIG. 6 is an example of the charger coordination controller 300, 320, and/or 340 of FIGS. 3A, 3B, and 3C, respectively.

As shown in FIG. 6, the charger coordination controller 105 includes an electronic controller 602, a wireless transceiver 604, a power circuit 606, electronic components 608.

The electronic controller 602 can include an electronic processor 620 and memory 622 storing instructions 624. The electronic processor 620, the memory 622, and the wireless transceiver 604 can communicate over one or more control buses, data buses, etc., which can include a device communication bus 626. In some examples, the electronic processor 620 and the memory 622 are configured generally similarly to the electronic processor 520 and memory 522 of FIG. 5, albeit with a different set of instructions stored on the memory 622 to account for the different functionality of the charger coordination controller 105. Accordingly, the discussion above with respect to the electronic processor 520 and the memory 522 similarly applies to the electronic processor 620 and the memory 622, unless otherwise noted. For example, the electronic processor 620 can be configured to receive instructions 624 and data from the memory 622 and execute, among other things, the instructions 624. In particular, the electronic processor 620 executes the instructions 624 stored in the memory 622. Thus, the controller 602 coupled with the electronic processor 620 and the memory 622 can be configured to perform or control the functions of the charger coordination controller 105 described herein, including the process 900 of FIG. 9A, described in further detail below.

In some examples, the wireless transceiver 604 is configured generally similarly to the wireless transceiver 504 of FIG. 5. Accordingly, the discussion above with respect to the wireless transceiver 504 similarly applies to the wireless transceiver 604, unless otherwise noted. For example, the wireless transceiver 604 enables the charger coordination controller 105 (e.g., the controller 602) to wirelessly communicate with power tool battery chargers and, in some examples, one or more of a laptop, mobile device, tablet, or other wireless computing device.

In some examples, the power circuit 606 can include an AC plug (e.g., configured to connect to conventional AC wall outlet), a DC plug configured to connect to a DC outlet, an internal battery (e.g., as described with respect to controller 300 of FIG. 3A), an electro-mechanical interface (e.g., as described with respect to controllers 320 and 340 of FIGS. 3B and 3C), and/or power conditioning circuitry (e.g., a filter, transformer, etc.). Power received via the Power Circuit 606 may power the other components of the charger coordination controller 105, including the electronic controller 602 and the wireless transceiver 606.

The electronic components 608 may include input/output interface elements enabling a user to interface (e.g., provide input and/or receive output) with the charger coordination controller 105 (e.g., via the electronic controller 602). For example, electronic components 608 can include a touch screen display, LEDs, speakers, push buttons, switches, selectors, dials, a charging port, and the like.

FIG. 7 is a block diagram of a power tool battery pack 700, according to some examples. The battery pack 700 may be an example of one of the battery packs 530 referenced in FIG. 5, as well as the battery packs illustrated in FIGS. 2A, 2B, 3C, 4A, and 4B.

The power tool battery pack 700 can include one or more battery cells of various chemistries, such as lithium-ion (Li-Ion), nickel cadmium (Ni-Cad), etc. The power tool battery pack 700 can further selectively latch and unlatch (e.g., with a spring-biased latching mechanism) to the power tool battery charger 500 to prevent unintentional detachment. The power tool battery pack 700 can further include an electronic controller 705 (also referred to as a pack controller 705) including an electronic processor 710 and a memory 715. The pack controller 705 can be configured generally similarly to the charger controller 502 of the power tool battery charger 500, including with the memory 715 storing instructions and the electronic processor 710 configured to retrieve and execute those instructions to carry out the functionality of the battery pack 700. The pack controller 705 can be configured to regulate charging and discharging of the battery cells, and/or to communicate with the charger controller 502. In some embodiments, the power tool battery pack 700 can further include transceiver, similar to the wireless transceiver 504, coupled to the pack controller 705 via a bus similar to bus 526. Accordingly, the pack controller 705, and thus the power tool battery pack 700, can be configured to communicate with other devices, such as the power tool battery charger 500 or other power tool battery chargers, a cellular tower, a Wi-Fi router, a mobile device, access points, etc. The power tool battery pack 700 can further include, for example, a display 730 (e.g., including a charge level fuel gauge), analog front ends, sensors, etc. The power tool battery pack 700 further includes a charger interface 740 configured to electrically and mechanically engage with the charger 500 (e.g., via the battery pack interface 508).

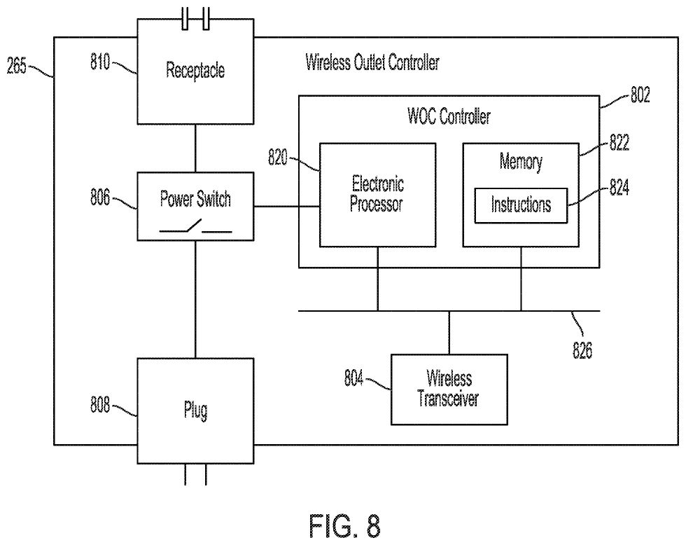

FIG. 8 is a block diagram of an example of the wireless outlet controller 265, according to some examples. The wireless outlet controller 265 illustrated in FIG. 8 is an example of the wireless outlet controller 265 included and illustrated in the charging system 250 of FIG. 2B, and referenced for inclusion in other charger systems described herein.

As shown in FIG. 8, the wireless outlet controller 265 includes an electronic controller 802, a wireless transceiver 804, a power switch 806, a plug 808, and a plug receptacle 810.

The electronic controller 802 can include an electronic processor 820 and memory 822 storing instructions 824. The electronic processor 820, the memory 822, and the wireless transceiver 804 can communicate over one or more control buses, data buses, etc., which can include a device communication bus 826. In some examples, the electronic processor 820 and the memory 822 are configured generally similarly to the electronic processor 520 and memory 522 of FIG. 5, albeit with a different set of instructions stored on the memory 822 to account for the different functionality of the wireless outlet controller 265. Accordingly, the discussion above with respect to the electronic processor 520 and the memory 522 similarly applies to the electronic processor 820 and the memory 822, unless otherwise noted. For example, the electronic processor 820 can be configured to receive instructions 824 and data from the memory 822 and execute, among other things, the instructions 824. In particular, the electronic processor 820 executes the instructions 824 stored in the memory 22. Thus, the controller 602 coupled with the electronic processor 6820 and the memory 822 can be configured to perform or control the functions of the wireless outlet controller 265 described herein.

In some examples, the wireless transceiver 804 is configured generally similarly to the wireless transceiver 504 of FIG. 5. Accordingly, the discussion above with respect to the wireless transceiver 504 similarly applies to the wireless transceiver 804, unless otherwise noted. For example, the wireless transceiver 804 enables the wireless outlet controller 265 (e.g., the controller 802) to wirelessly communicate with the charger coordination controller 105, power tool battery chargers and, in some examples, one or more of a laptop, mobile device, tablet, or other wireless computing device.

The plug 808 is configured to and enables the wireless outlet controller 265 to connect to a power source and receive power. In some examples, the plug 808 is a two-or three-terminal AC plug configured to engage with a conventional AC wall outlet. In other examples, the plug 808 provides terminals has another form. The power received via the plug 808 may power the other components of the wireless outlet controller 265, including the WOC controller 802 and the wireless transceiver 804.

The plug receptacle 810 is configured to and enables the wireless outlet controller 265 to connect to a charger (e.g., the charger 500 or another charger described herein) and to supply power to the charger. In some examples, the plug receptacle 810 includes a two-or three-terminal receptacle configured to engage with a conventional AC plug (e.g., of the charger).

In some examples, the power switch 806 can include a relay, field effect transistor, or another controllable switch that is controlled by the WOC controller 802. In particular, the WOC controller 802 is configured to control the power switch 806 to close, thereby electrically connecting the plug 808 to the receptacle 810 (enabling power to flow therethrough), and configured to control the power switch 806 to open, thereby electrically disconnecting the plug from the receptacle (disabling power flow therethrough). As described further below, the WOC controller 802 is configured to receive charging instructions, wirelessly via the wireless transceiver 804, from, for example, the charger coordination controller 105. The controller 802 is further configured to control the power switch 806 in response to the charging instructions.

FIG. 9A is a flowchart illustrating a process 900 of charging power tool battery packs according to some examples. Process 900 can be executed by the charger coordination controller 105, as described with respect to one or more of the charging systems 100, 200, 250, 400, and 425. One or more algorithms for performing process 900 can be stored in instructions 624 in memory 622, and executed by electronic processor 620, for example. Although the blocks of process 900 are illustrated in a particular order, one or more of the blocks may be executed in another order or in parallel (partially or entirely) with another block or blocks of the process 900. Although the process 900 is described with respect to the charger coordination controller 105 and systems 100, 200, 250, 400, and 425, in some examples, the process 900 is executed by another device or within another system.

At block 905, an electronic processor receives, via a wireless transceiver, charger information from a plurality of power tool battery charger systems. For example, with reference to FIG. 6, the electronic processor 620 (and, thus, the electronic controller 602 and the charger coordination controller 105) receives charger information via wireless transceiver 605. The charger information may be transmitted by, and received from, a plurality of power tool battery charger systems 110 (e.g., in the form of the charger systems 210 of FIG. 2A and/or the charger systems 260 of FIG. 2B) coupled to the same power network 125 or circuit breaker 235. Accordingly, in some examples, the charger information is received from battery chargers (e.g., battery chargers 230) of the charger systems 110 (e.g., in the form of charger systems 210). In other examples, the charger information is received from wireless outlet controllers (e.g., wireless outlet controllers 265) of the charger systems 110 (e.g., in the form of charger systems 260). In some examples, when a power tool charger system 100 includes charger systems 110 both in the form of charger systems 210 (FIG. 2A) and in the form of charger systems 260 (FIG. 2B) coupled to the same power network, the charger information is received from a combination of battery chargers (e.g., of charger systems 210) and wireless outlet controllers (e.g., of charger systems 260).

As described above, the charger information may include, for example, one or more of: a charger identifier, a battery pack identifier, a charger ready indication, a battery pack docked indication, expected current draw based on a docked battery pack, present current draw of the charger, charger settings, or the like.

In some examples, the plurality of power tool battery charger systems may be registered (e.g., in advance of block 905 or as part of block 905) with the charger coordination controller 105 as being a group of charger systems coupled to a same power circuit (e.g., a same power network 125, a same circuit breaker 235, or a same outlet 240). For example, a user may transmit identifications of the plurality of power tool battery charger systems (to be considered in the group) to the charger coordination controller 105 using a user computing device (e.g., mobile device, laptop, or tablet). For example, the user computing device may include a display and a graphical user interface, via which the user may enter identifying information to identify the plurality of power tool battery charger systems. In some examples, the user computing device may scan a bar code or communicate with the power tool battery charger systems 110 to obtain the identities thereof, and may communicate these identifies to the charger coordination controller 105. In some examples, the charger information may indicate the identities of the plurality of power tool battery charger systems 110 that are considered in the group coupled to the same power circuit.

At block 910, the electronic processor determines a charger subset of the plurality of power tool battery charger systems to be enabled based on the charger information, the charger subset including at least a first power tool battery charger system of the power tool battery charger systems. For example, with reference to FIG. 6, the electronic processor 620 (and, thus, the electronic controller 602 and the charger coordination controller 105) determines the charger subset based on the charger information. The charger subset may include at least one of the charger systems 110, 210, or 260, or a combination of charger systems 110, 210, or 260.

As an example, to determine the subset, the electronic processor 620 may determine a current threshold for the plurality of power charger systems. The current threshold may be indicated by the charger information (e.g., based on a charging setting including an indication by the amperage limit selector 516), may be indicated by default setting of the charger coordination controller 105, or may be indicated by the user to the charger coordination controller 105 (e.g., via a selector thereon or via communication with a user computing device). Additionally, to determine the subset, the electronic processor 620 may determine a potential list of charger systems (e.g., based on charger identifiers received in the charger information) and select the subset from the potential list such that the current threshold is not expected to be exceeded. For example, to select the subset, the electronic processor 620 may remove from the potential list of charger systems those chargers (i) that did not indicate charger was ready based on a charger ready indicator provided in the charger information and (ii) that did not indicate a battery was docked based on a battery pack docked indication provided in the charger information. From the remaining potential list of charger systems, the electronic processor 620 may assign an expected current draw for each charger system. The expected current draw for each charger system may be based on an expected current draw communicated from the particular charger system as part of the charger information, may be based on a default current draw value that is charger agnostic (e.g., for some charger systems with wireless outlet controllers), may be based on a default current draw value that corresponds to the particular type of battery charger and/or coupled battery pack, or may be based on other factors.

The electronic processor 620 may then apply a priority scheme to select the subset of charger systems from the remaining potential list of charger systems such that the sum of the associated expected current draw for the subset does not exceed the current threshold. The priority scheme may prioritize the number of chargers enabled (e.g., selecting those chargers with lowest expected current draw to increase the number of chargers enabled), may prioritize based on charger identifier and previously indicated user priority levels for the charger systems, may prioritize based on battery pack state of charge (e.g., to prioritize “topping-off” minimally or partially depleted battery packs first before charging fully or more depleted battery packs, or vice versa). Accordingly, as part of the determination of the subset, the electronic processor 620 may compare an expected current draw of the subset to the current threshold to ensure the expected current drawn is below the current threshold. In some examples, the subset is limited to a predetermined number of chargers (e.g., one, two, three, four, or five charger systems), and the electronic processor 620 selects the chargers using a priority scheme as described above, or based on a scheme unrelated to impact on current draw (e.g., random, order of registration with the controller 105, etc.). In some examples, the electronic processor 620 may prioritize charging each battery pack to a first threshold (e.g., 75%, 80%, or 85%) first, before proceeding to charge battery packs completely (e.g., to a second threshold, for example, 100%). In some examples, a user input is received by the charger coordination controller 105 specifying whether to prioritize (i) fully charging battery packs versus (ii) charging battery packs to 80% first, then fully charging the battery pack. The charger coordination controller 105 may then, in response, prioritize charging according to the user input.

At block 915, the electronic processor transmits, via the wireless transceiver, a charger enabling instruction to the charger subset. For example, with reference to FIG. 6, the electronic processor 620 (and, thus, the electronic controller 602 and the charger coordination controller 105) transmits the enabling instruction to the charger subset via the wireless transceiver 604. In some examples, the enabling instruction may include a broadcast instruction including a list of charger identifiers associated with the charger systems in the charger subset. In some examples, the enabling instruction may include one or more individual transmitted instructions, each addressed to a particular charger system in the charger subset. The enabling instruction indicates, to the charger systems of the charger subset receiving the instruction, to charge battery packs (e.g., battery packs 530) coupled thereto. In some examples, where the charger systems includes battery pack interface (e.g., interface 508) configured to receive multiple battery packs 530, the enabling instruction indicates which of the battery packs 530 to charge or how many battery packs 530 to simultaneously charge. The enabling instruction indicates, to the charger systems of the charger subset receiving the instruction, a current limit under which the charger system should remain while charging battery packs (e.g., battery packs 530) coupled thereto.

In response to receipt of the charging enabling instruction, the charger systems of the charger subset may begin or continue charging of engaged battery packs (e.g., packs 530) in accordance with the charger enabling instruction. For example, in the case of a charger systems 210 (see FIG. 2A) receiving a charger enabling instruction, the battery charger 230 may begin charging one or more coupled battery packs. With reference to FIG. 5, where the battery charger 500 is an example of the battery charger 230, the charger controller (e.g., via the electronic processor 520) may control the charging circuit(s) 510 to charge one or more of the battery pack(s) 530. As another example, in the case of a charger system 260 (see FIG. 2B) receiving the charger enabling instruction, the wireless outlet controller 265 may be controlled to enable power to flow through to the corresponding charger 275, which may then proceed with charging one or more coupled battery packs. For example, with reference to FIG. 8, the wireless outlet controller 265 (e.g., via the WOC controller 802 and electronic processor 820) may control the power switch 806 to close, thereby enabling power to flow through from the plug 808 to the receptacle 810, and thereby through to a coupled charger (e.g., a charger 275).

Accordingly, by implementing the process 900, charging by power tool battery charging systems can be coordinated to avoid tripping a circuit breaker or otherwise exceeding a current threshold by the charging systems collectively.

In some examples, in block 915, in addition to transmitting a charger enabling instruction, the electronic processor 620 transmits, via the wireless transceiver 604, a charger disabling instruction is transmitted to one or more power tool battery charger systems of the plurality of power tool battery charger systems that are not included in the charger subset. The charger disabling instruction indicates, to the charger systems that receive the instruction, to not charge or cease charging of power tool battery pack(s).

In some examples, the process 900 may be looped or repeated periodically or continuously. In such examples, the charger coordination controller 105 may repeatedly receive further charger information (in block 905), determine an updated charger subset based on the updated charger information (in block 910), and transmit a further charger enabling instruction to the updated charger subset (in block 915). The further charger information may include a charger progress of the charger subset. For example, the charger progress may indicate that one or more battery chargers of the charger subset has completed charging or is nearing completion of charging (and, accordingly, the current draw has decreased or is decreasing). The updated charger subset (e.g., a second charger subset on a second pass through the process 900, a third charger subset on a third pass through the process 900, etc.) may be different then the charger subset initially determined. For example, the updated charger subset may, for example, include a second power tool battery charger system of the power tool battery charger systems, not include the first power tool battery charger system, or both. In some examples, in addition to transmitting the further charger enabling instruction, in block 915, the charger coordination controller 105 also transmits an updated charger disabling instruction to those charger systems of the plurality of charger systems (not in the updated charger subset) that should not charge or cease charging.

In some examples, the communications in blocks 905 and 915 may be direct between the charger coordination controller 105 and the plurality of power tool battery charger systems or charger subset (see, e.g., star network of FIG. 4B). For example, the charger coordination controller 105 my iteratively pair (e.g., form a communication link) with each charger system 110 to receive the charger information therefrom. In other examples, the charger coordination controller 105 may broad cast a message requesting the charger information, and then receive responses to the request from each charger system 110 that received the broadcast message. In some examples, the communications in blocks 905 and 915 may be indirect between the charger coordination controller 105 and the plurality of power tool battery charger systems or charger subset (see, e.g., mesh network of FIG. 4A). For example, in block 905, and with reference to FIG. 4A, a portion of the charger information from charger system 110-1 may be receive by the charger coordination controller 105 via the charger system 110-3 (or one or more other charger systems 110). Similarly, the charger enabling instruction of block 915 may be transmitted to a charger system of the charger subset (e.g., charger system 110-1) via another charger system (e.g., the charger system 110-3).

As noted above, the charger coordination controller 105 may be in a standalone housing external to the plurality of battery charger systems (e.g., not integrated into a battery charger or wireless outlet controller). For example, the charger coordination controller 105 may be implemented as the charger coordination controllers 300, 320, or 340 of FIGS. 3A, 3B, and 3C, respectively. In other examples, the charger coordination controller 105 may be integrated into a second power tool battery charger system of the plurality of power tool battery charger systems (e.g., integrated into a battery charger 500 or wireless outlet controller 800). For example, in such examples, the instructions 624 (see FIG. 6) may be incorporated into the memory 522 of the charger 500 (see FIG. 5) or into the memory 822 of the wireless outlet controller 800 (see FIG. 8). Accordingly, the electronic processor 520 may execute the instructions 624 to cause the charger 500, or the electronic processor 820 may execute the instructions 624 to cause the wireless outlet controller 800, to implement the functionality of the charger coordination controller 105 described herein. In another example, the charger coordination controller 105, including the electronic controller 602 and wireless transceiver 604, may be added to (e.g., in the housing of) the battery charger 500 or wireless outlet controller 800.

In some examples, each of the plurality of battery charger systems 110 has integrated therein a charger coordination controller 105, and one of them is selected to serve as the charger coordination controller 105 for the plurality of charger systems 110. For example, the first battery charger system of the charger systems 110 to receive AC power (e.g., be plugged into an AC outlet 240), the first battery charger system of the charger systems 110 to receive a battery pack for charging, a battery charger system having a highest hard-coded priority number of the charger systems 110, a physical button of a battery charger system being set to be the primary coordinating charger, or the like may be used by the charger systems 110 to identify one of the charger coordination controllers 105 to serve as the charger coordination controller 105 for the plurality of charger systems 110 (e.g., implementing the process 900 of FIG. 9A).

In some examples, the plurality of battery charger systems 110 implement a mesh network (see, e.g., FIG. 4A), each of the plurality of battery charger systems 110 has integrated therein a charger coordination controller 105, and the charger coordination controllers 105 implement a distributed control algorithm without a central decision-making controller. For example, each of the charger systems 110 may exchange charger information with one another and decide, for themselves based on the received information, whether to initiate charging. For example, each charger system 110 may be configured to compare its charger information to received charger information and determine whether, according to the distributed control algorithm, the charger system 110 should initiate charging. The distributed control algorithm may define a charging priority (e.g., based on battery charge level, the first battery charger system of the charger systems 110 to receive AC power (e.g., be plugged into an AC outlet 240), the first battery charger system of the charger systems 110 to receive a battery pack for charging, a battery charger system having a highest hard-coded priority number of the charger systems 110, etc.) that each of the charger systems 110 may then apply to the charger information to determine whether to initiate charging of a coupled battery pack.

FIGS. 9B, 9C, 9D, and 9E illustrate additional flowcharts illustrating a method of charging power tool battery packs according to some examples. More particularly, FIGS. 9B and 9C illustrate a method implemented by a charging station, such as, for example, one of the charger systems 110, 210, or 260, according to some examples. FIGS. 9D and 9E illustrate a method implemented by a charger coordination controller, such as, for example, the charger coordination controller 105, according to some examples. In some examples, the method illustrated in FIG. 9D and E may be executed by a charging coordination controller 105 in parallel with execution of the method illustrated in FIGS. 9B and 9C by a charging station.

Turning first to FIGS. 9B and 9C, the method of FIGS. 9B and 9C may begin at a charging station booting phase 920. At step 922, an initiation function (e.g., “S_BOOT”) may be performed by the charging station (e.g., upon a power cycle or upon being connected to a power source). The initiation function may cause the charging station to turn off. Next, the charging station may determine whether that station is paired to a controller (e.g., a charger coordination controller 105) at step 924. When no controller is paired, the charging station may perform a pairing process at step 926. In some examples, the pairing process may include iteratively attempting to pair the charging station with a controller via a communication link until the charging station is successfully paired and a communication link is formed with the controller.

Once the charging station is paired to a controller, the charging station may enter a standard charging station phase 928. In some examples, the standard charging station phase 910 may include logic or functionality of a loop, causing the steps within the phase 928 to be looped or repeated periodically or continuously. The standard charging station phase 928 may occur in the background whenever one or more battery packs are actively charging. At step 930, the charging station may determine whether a battery pack is engaged with one or more chargers in the charging station. Further, the charging station may determine whether charging may begin when the charging station detects one or more engaged battery packs (e.g., packs 530). When no packs are detected, or when the charging station determines that charging may not yet begin, the charging station continues to step 932, where the charging station determines whether a period of time associated with a check-in period (e.g., “T_CHECKIN_PERIOD”) has passed. When the period of time has not passed, the charging station moves to step 934, where it waits an allotted amount of time (e.g., “T_SAMPLE_ADC”) to obtain one or more measurements associated with the current draw of the charging station. Once the allotted amount of time has passed, the charging station loops back to step 930.

When the charging station determines that one or more battery packs is engaged with the charging station, the charging station continues to step 936, where the current readings are obtained. At step 938, the charging station determines, using the current reading, whether tapering charging is occurring. In some examples, taper charging may reduce the current draw of a charger when the associated pack or packs of the charging station are approaching or at a fully charged state. When taper charging is not occurring, the charging station returns to step 932. When the check-in period has passed as determined in step 932, the charging station enters a charging station connection phase 940.

Additionally, when taper charging is occurring, the charging station turns off the charging station at step 938 and enters a charging station connection phase 940. The charging station connection phase 940 may occur after all of the packs in the charging station have reached a fully charged state (e.g., as indicated by taper charging occurring) and/or after the check-in period has passed.

The charging station connection phase 940 may begin with the charging station trying to connect to a controller (e.g., the controller to which the charging station is paired). When the connection between the charging station and the controller is not successful, the charging station may wait for a timeout period to pass (e.g., “T_CHECKIN_TIMEOUT”) before turning off the charging station at step 942 and returning to the standard charging station phase 928. When the connection between the charging station and the controller is successful, the charging station continues to step 944, where the charging station sends data to a memory of the controller and receives response data stored in the memory of the controller (e.g., memory 522). For example, the charging station may transmit the charger information described above with respect to block 905 of FIG. 9A and/or receive a charger enabling (or disabling) instruction as described with respect to block 915 of FIG. 9A. Accordingly, in some examples, the data may include information corresponding to the power draw of any charging battery packs and/or the capacity of the controller to provide current to the charging station. Next, the charging station continues back into the standard charging station phase 928.

In some examples, one or more packs may be inserted or removed into the charging station, causing the charging station to enter a charging station pack detection phase 946. At step 948, a pack state change is detection. The pack state change may be detected based on, for example, an associated change in the current draw from the charging station when one or more packs are inserted or removed and/or completion or interruption of a circuit loop between the charging station and the one or more packs via connecting terminals thereof. When the charging station determines that one or more packs are inserted at step 950, the charging station proceeds to step 952 and waits until the advertised capacity of the controllers is large enough to accommodate the additional pack(s). In some examples the advertised capacity may correspond to the controller's assessment of whether sufficient current is available to charge another battery pack (see, e.g., block 910 of FIG. 9A). Next, the charging station enters into the charging station connection phase 940 at block 958, where the charging station tries to connect to the controller. When the charging station determines that one or more packs are removed at step 954, the charging station whether that the charging station was charging the removed battery pack at step 956. When the charging station determines that the charging station was not charging, the charging station proceeds to block 952 and may wait until the advertised capacity of the controllers is large enough to accommodate any remaining packs thereon or until further pack is added (returning the charging station to block 948 of the charging station pack detection phase). When the charging station determines that the charging station was charging the removed battery pack, the charging station proceeds to the charging station connection phase 940 at block 958.

As noted above, FIG. 9C illustrates a method implemented by a charger coordination controller (e.g., the charger coordination controller 105) and may be executed in parallel with one or more charging stations each executing the method illustrated in FIG. 9B. In some examples, to implement the process 900 of FIG. 9A, the charger coordination controller 105 executes the method illustrated in FIGS. 9D and 9E. However, in other examples, the charger coordination controller 105 implements the process 900 of FIG. 9A using other techniques.

In FIGS. 9C and 9E, the method may begin at a controller booting phase 960. At step 962, an initial function (e.g., “BOOT”) may be performed by the controller. Next, the controller waits for an allotted amount of time to pass to allow any previously enabled stations to connect with the controller and send their respective data. Next, the controller enters a controller forever loop phase 964. In some examples, the controller forever loop phase 964 may include logic or functionality of a loop, causing the steps within the phase 964 to be looped or repeated periodically or continuously. The steps in the controller forever loop phase 954 may occur in the background to update the controller's capacity when one or more charging stations are detected and/or enabled.

During the controller forever loop phase 964, the controller waits for a period to pass at step 966. In some examples, the period may be 30 seconds; in other examples, the period may be more or less time (e.g., in a range 20-40 seconds, 10-60 seconds, etc.). Next, the controller determines whether any enabled stations have not checked-in within a specified time period (e.g., 3 minutes, or a period between 2-4 minutes, 1-5 minutes, etc.). When an enabled station has not been checked in, the controller resets the charging station's data at step 968. Moreover, the controller increases or increments a capacity of the system previously determined with a previously allocated current draw for that charging station.

Additionally, the controller may enter a connection and case handling phase 970. In some examples, the connection and case handling phase 970 may be executed in parallel with the controller forever loop phase 964. The controller may receive data from a connected charging station at step 972, where the controller and the connected charging station are connected via a wireless communication link. For example, the controller may receive charger information from the connected charging station as described with respect to block 905 in FIG. 9A. In some examples, the data may include an indication of battery packs being actively charged, battery packs finished charging, battery packs entering a taper charging state, and/or a number of available chargers available in the charging station. Based on the data received from the connected charging station, the controller may categorize the charging station into four cases at step 974.

The first case may correspond to a charging station in which a battery pack was inserted. In this case, the controller determines that the system has sufficient capacity to provide charge to an engaged pack of the charging station. This case may occur while the charging station is in the charging station pack detection phase 946, described above with respect to FIG. 9C. When the controller categorizes the charging station into this first case, the controller determines whether there is enough capacity to allow the station to charge, at step 976. When there is not enough capacity, the controller disconnects with the charging station (e.g., severs or terminates the wireless communication link) at step 978. When there is enough capacity, the controller provides a charger enabling instruction to the charging station (see, e.g., block 915 of FIG. 9A)) and decreases the capacity of the system determined by the controller based on the current to be supplied by the charging station at step 980. Additionally, the capacity advertisement transmitted by the controller is updated with the new (decremented) capacity at step 982. Finally, the controller disconnects with the charging station (e.g., severs or terminates the wireless communication link) at step 978.

The second case may correspond to a charging station from which a battery pack was removed. The removal of the battery pack allows the controller to determine that additional power is available for the charging station or another charging station to charge one or more other battery packs. This case may occur while the charging station is in the charging station pack detection phase 946, described above. When the controller categorizes the charging station into this case, the controller updates the capacity of the system determined by the controller at step 984, as the removed battery pack may cause the charging station or a charger of the charging station to turn off. Next, the controller continues to step 982, where the advertisement is updated with the new (increased) capacity. Finally, the controller disconnects with the charging station (e.g., severs or terminates the wireless communication link) at step 978.

The third case may correspond to a charging station actively running in the standard charging station phase 928, wherein an update is being provided to the connected controller. This case may occur while the charging station is in the standard charging station phase 928, described above. When the controller categorizes the charging station into this case, the controller updates its capacity with any newly obtained information at step 986, corresponding to the data received. Next, the controller continues to step 982, where the advertisement is updated with the new capacity (which may or may not be different than the previously determined capacity, depending on the newly obtained information). Finally, the controller disconnects with the charging station (e.g., severs or terminates the wireless communication link) disconnected at step 978.

The fourth case may correspond to a charging station which is taper charging, as described in step 938 of FIG. 9B. This case may occur while the charging station is in the standard charging station phase 928, described above. When the controller categorizes the charging station into this case, the controller updates its capacity at step 986, as the taper charging may indicate that the charging station or a chargers of the charging station will be turned off. Next, the controller continues to step 982, where the advertisement is updated with the new capacity. Finally, the controller disconnects with the charging station (e.g., severs or terminates the wireless communication link) at step 978.

In some examples, the charging station may not be categorized into any of the above-described cases. This may occur due to a charging station being turned off or power cycled. In other examples, the charging station may not be categorized when the controller is turned off or power cycled. In this case, the controller may determine whether the charging station is indicating that it is charging one or more battery packs at step 988. When the charging station does not indicate it is charging one or more battery packs, the controller disconnects with the charging station (e.g., severs or terminates the wireless communication link) at step 978. When the charging station does indicate that one or more battery packs are charging, the controller decreases the capacity based on the current draw indicated by the charging station at step 990. Finally, the controller disconnects with the charging station (e.g., severs or terminates the wireless communication link) is disconnected at step 978.

In another example, the charger coordination controller 105 may connects to each charger system 110, 210, or 260, one at a time (or two at a time, or three at a time, etc.) and allows charging of those charger systems. Upon receipt of a communication from an enabled charger system that charging of battery packs coupled thereto is complete, the charger coordination controller 105 may connect to the next charger system 110, 210, or 260. The charger coordination controller 105 may, accordingly, cycle through each charger, one-by-one (or two-by-two, three-by-three, etc.) until each charger system has completed charging battery packs coupled thereto. The charger coordination controller 105 may cycle through the charger systems 110, 210, or 260 by following a predetermined order of known charger systems, prioritizing charger systems by strongest (or weakest) wireless signals, or another approach.

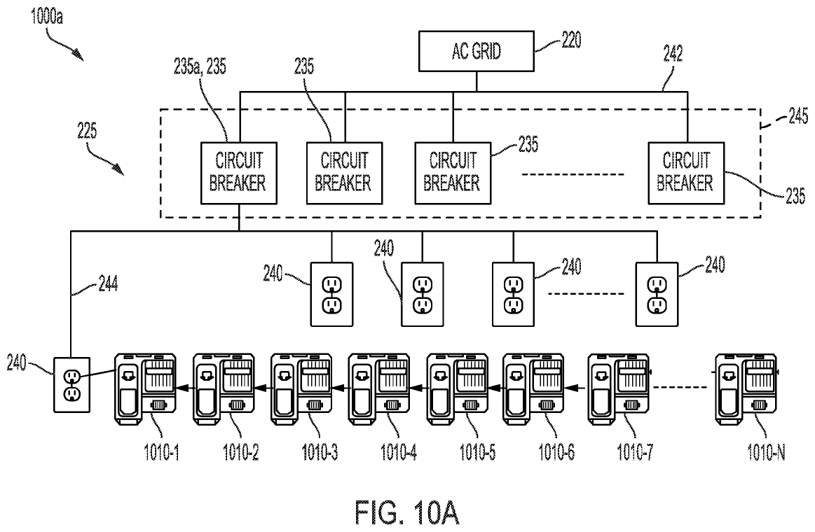

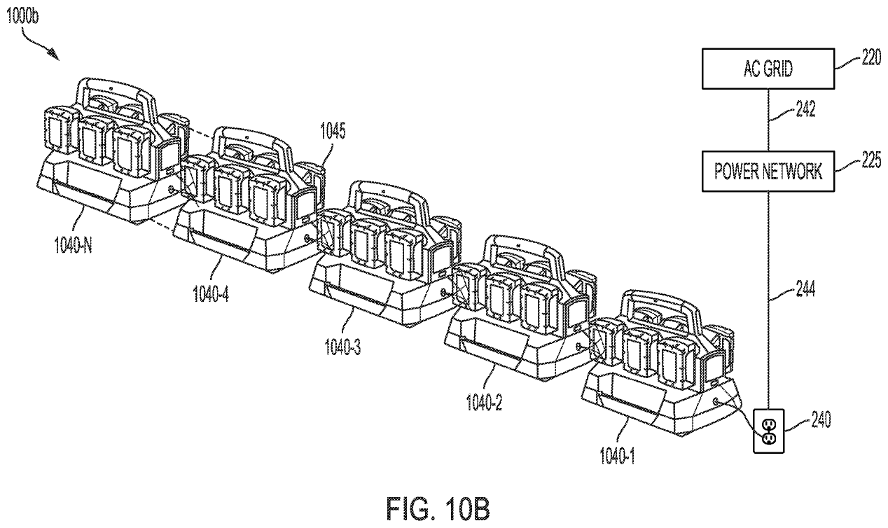

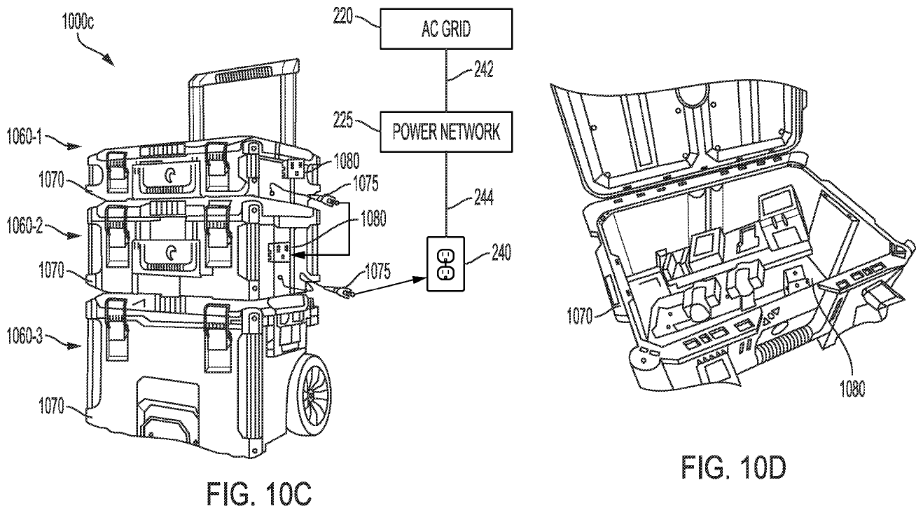

FIGS. 10A, 10B, 10C, and 10D illustrate charging systems 1000a, 1000b, and 1000c. As discussed further below, each of the charging systems 1000a, 1000b, and 1000c includes power tool battery chargers daisy-chained together and configured to selectively activate to coordinate charging. By coordinating the charging, the battery chargers can maintain a total current drawn by the battery chargers below a threshold. By maintaining the total current drawn below the threshold, the charging of power tool battery packs by the battery chargers can, for example, avoid exceeding a current threshold of a corresponding power circuit or breaker (e.g., avoid “tripping” a circuit breaker).

FIG. 10A illustrates a charging system 1000a for charging power tool battery packs according to some examples. The charging system 1000a includes a plurality of power tool battery pack chargers 1010-1 to 1010-N (herein, chargers 1010), which may be coupled to a power supply via a power network. For example, as illustrated, the chargers 1010 are coupled to a power supply 220 (also referred to as an AC grid 220) via a power network 225. The power supply 220 and the power network 225 of FIG. 10A, including the components thereof (e.g., the power lines 242, panel 245, circuit breakers 235, outlets 240, and power lines 244) may be similar to the like-numbered elements of FIGS. 2A and 2B, the discussion of which is incorporated herein. Further, a charger of the chargers 1010 may be referred to generically as a charger 1010 or collectively as the chargers 1010.

The chargers 1010 are daisy-chained together and to the outlet 240. That is, a first charger 1010-1 is coupled to the outlet 240, the charger 1010-2 is coupled to the charger 1010-1, the charger 1010-3 is coupled to the charger 10102, and so on. As described further below, each charger 1010 may include a power cord (e.g., with a plug) to connect to a receptacle (e.g., outlet 240) to receive power, and a daisy-chain outlet to receive a power cord plug of another charger 1010 that is downstream.

The chargers 1010 illustrated in FIG. 10A are combo-chargers operable to receive and charge two types of battery packs, each having a respective formfactor and nominal voltage. In other examples, the charger systems 210 include different types of battery chargers than illustrated and/or different combinations of battery chargers than illustrated. For example, the battery chargers may include single-pack chargers (e.g., for charging the first type or second type of battery pack), multi-pack, single-type chargers (e.g., for charging multiple of the first type or multiple of the second type of battery pack, as shown in FIG. 10B), charger systems 1060 (described with respect to FIG. 10C), and/or chargers for charging other types of power tool battery packs than those shown (e.g., packs with nominal voltages above 24 volts, such as packs with nominal voltages between 24 and 120 volts).

FIG. 10B illustrates a charging system 1000b for charging power tool battery packs according to some examples. The charging system 1000b is similar to the charging system 1000a, except for the chargers 1040-1 to 1040-N (herein, chargers 1040) are substituted in for the chargers 1010. Accordingly, the power supply 220 and the power network 225 of FIG. 10B may be similar to the like-numbered elements of FIGS. 2A, 2B, and 10A, the discussion of which is incorporated herein. In contrast to the chargers 1010, the chargers 1040 are multi-pack, single-type chargers for charging six of a same type of battery pack 1045. The chargers 1040, similar to the chargers 1010, are daisy-chained together and to the outlet 240. As with the charger 1010, each charger 1040 may include a power cord (e.g., with a plug) to connect to a receptacle (e.g., outlet 240) to receive power, and a daisy-chain outlet to receive a power cord plug of another charger 1040 that is downstream. Further, a charger of the chargers 1040 may be referred to generically as a charger 1040 or collectively as the chargers 1040.

FIG. 10C illustrates a charging system 1000c for charging power tool battery packs according to some examples. The charging system 1000c is similar to the charging system 1000a and 1000b, except for the charger systems 1060-1 to 1060-N (herein, charger systems 1060) are substituted in for the chargers 1010 and 1040, respectively. Accordingly, the power supply 220 and the power network 225 of FIG. 10C may be similar to the like-numbered elements of FIGS. 2A, 2B, 10A, and 10B, the discussion of which is incorporated herein. Further, a charger system of the charger systems 1060 may be referred to generically as a charger system 1060 or collectively as the charger systems 1060.

In contrast to the chargers 1010 and 1040, the charger systems 1060 are combined tool container-battery charger units. That is, each charger system 1060 includes a battery charger 1065 (e.g., similar to the charger 1010 or charger 1040) integrated with a tool storage container 1070. The tool storage container includes walls and a hinged lid that define a storage volume. As shown in FIG. 10D, the storage volume may receive the battery charger 1065. Additionally, the storage volume may have additional space in which to store other equipment (e.g., power tools, power tool batteries, work clothing, safety equipment, etc.). The size or storage volume of the storage containers 1070 may vary, as illustrated in FIG. 10C.

Further, each of the tool storage containers 1070 of the charger systems 1060 include an interlocking interface on a top-side of the lid and bottom interlocking interface on bottom-side of the tool storage container. The interlocking interfaces support selectively stacking the tool storage containers 1070 in a secure manner (e.g., to avoid a stacked container from falling off of the stack). Accordingly, a first interlocking interface (e.g., bottom-side interface) of a first tool storage container 1070 may engage a second interlocking interface (e.g., top-side interface) of a second tool storage container 1070 provide the first tool storage container in a stacked arrangement with the second tool storage container. The interlocking interfaces may include corresponding projections and receptacles that snuggly fit together to provide the interlocking function.

The charger systems 1060, similar to the chargers 1010 and 1040, are daisy-chained together and to the outlet 240. As with the charger 1010, each charger system 1060 may include a power cord 1075 (e.g., with a plug) to connect to a receptacle (e.g., outlet 240) to receive power, and a daisy-chain outlet 1080 to receive a plug of a power cord 1075 of another charger system 1060 that is downstream. As illustrated, the daisy-chain outlet 1080 and the plug of the power cord 1075 may be on an external surface of the storage containers.

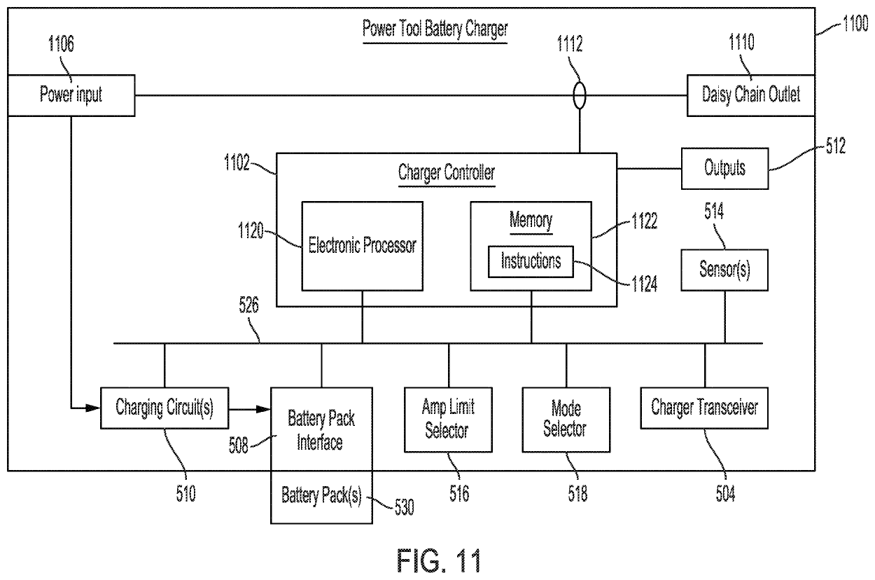

FIG. 11 is a block diagram of a power tool battery charger 1100, according to some examples. The power tool battery charger 1100 (also referred to as the battery charger 1100) is an example of a battery charger 1010 (FIG. 10A), a battery charger 1040 (FIG. 10B), and a battery charger 1065 (FIG. 10D) included in a charging systems 1000a, 1000b, and 1000c, respectively.

The battery charger 1100 has several similar components as the battery charger 500 of FIG. 5. More particularly, components of the battery charger 500 having like number with the battery charger 1100 are similar and the discussion above with respect to the components of the battery charger 500 similarly applies to the like numbered components of the battery charger 1100, except for any differences noted herein. Additionally, the battery charger 1100 includes a charger controller 1102 including an electronic processor 1120 and a memory 1122 storing instructions 1124, which are generally and structurally similar to, respectively, the charger controller 502, the electronic processor 520, the memory 522 storing instructions 524. Accordingly, the discussion above with respect to these corresponding components of the battery charger 500 similarly applies to the like named components of the battery charger 1100, except for any differences noted herein. For example, the instructions 1124 may be revised, relative to the instructions 524, to account for the varied functionality of the charger 1100 relative to the charger 500 discussed herein.

The battery charger 1100 may further include a power input 1106, a daisy chain outlet 1110, and a current sensor 1112. The power input 1106 may be similar to the power circuit 506, and may include a power cord with plug (see, e.g., power cord 1075 of FIG. 10C) configured to be coupled to a power outlet (e.g., power outlet 240) or a daisy chain outlet of another instance of the battery charger 1100. The power input 1106 may be coupled to the daisy chain outlet 1110 to provide power thereto. The current sensor 1112 may be configured to sense current at the daisy chain outlet 1110 (e.g., current flowing through the daisy chain outlet 1110 to a downstream device). Although separately illustrated, the current sensor 1112 may be part of the sensors 514. Further, in some examples, the battery charger 1100 may not communicate with a charger coordination controller 105. The charger transceiver 504, however, may be used by the charger controller 1102 to communicate with other computing devices for other purposes (e.g., configuration of the battery charger 1100, exporting battery information, etc.).

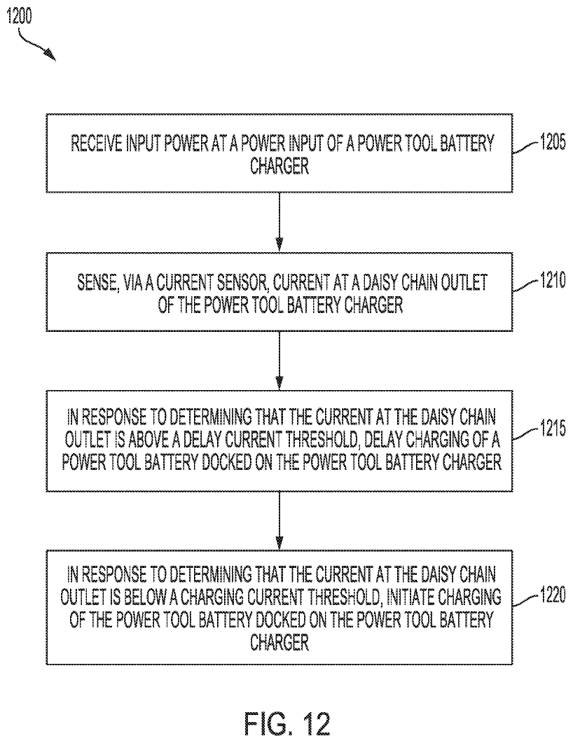

FIG. 12 a flowchart illustrating a process 1200 of charging power tool battery packs according to some examples. Process 1200 can be executed by the charger 1100 and, more particularly, by the charger controller 1102 of the battery charger 1100 of FIG. 11, for example, as described with respect to one or more of the charging systems 1000a, 1000b, and 1000c. One or more algorithms for performing process 1200 can be stored in instructions 1124 in memory 1122, and executed by electronic processor 1120, for example. Although the blocks of process 1200 are illustrated in a particular order, one or more of the blocks may be executed in another order or in parallel (partially or entirely) with another block or blocks of the process 1200. Although the process 1200 is described with respect to the charger controller 1102 and systems 1000a, 1000b, and 1000c, in some examples, the process 1200 is executed by another device or within another system.

At block 1205, a power input of a power tool battery charger receives input power. For example, the battery charger 1100 receives input power at the power input 1106. The input power may be received from a power supply 220 via a power network 225, or from daisy chain outlet of another instance of the battery charger 1100 (an upstream charger).

At block 1210, the charger controller senses, via a current sensor, current at a daisy chain outlet of the power tool battery charger. For example, the charger controller 1102 senses, via the current sensor 1112, current at the daisy chain outlet 1110 of the power tool battery charger 1100. In some examples, the current sensors 1112 may output to the charger controller 1102 a voltage signal having a voltage level corresponding to the current measured by the current sensor 1112.

At block 1215, in response to determining that the current at the daisy chain outlet is above a delay current threshold, the charger controller may delay charging of a power tool battery docked on the power tool battery charger. For example, the charger controller 1102 may compare the current sensed in block 1210 to a delay current threshold (e.g., obtained from the memory 1122). In response to the comparison indicating that the current is above the delay current threshold, the charger controller 1102 may transmit a command the charging circuits 510 to not charge the battery pack(s) 530 coupled to the battery pack interface 508 (e.g., until further notice).

The delay current threshold may be indicated by the amp limit selector 516. In some examples, the amp limit selector 516 indicates, for example, 15 A or 20 A as an amp limit of the power network 225 to which the battery charger 1100 is coupled. The delay current threshold may be a value calculated based on the amp limit. For example, the delay current threshold may be the amp limit less an expected current draw that the battery charger 1100 will draw when charging of the battery pack(s) 530 commences.

At block 1220, in response to determining that the current at the daisy chain outlet is below a charging current threshold, the charger controller initiates charging of the power tool battery docked on the power tool battery charger. For example, the charger controller 1102 may compare the current sensed in block 1210 to the delay current threshold. In response to the comparison indicating that the current is below the delay current threshold, the charger controller 1102 may transmit a command the charging circuits 510 to charge the battery pack(s) 530 coupled to the battery pack interface 508.

In some examples, the process blocks 1210, 1215, and 1220 may be looped or repeated periodically or continuously while input power is received at the power input (in block 1205). In such examples, the charger controller 1102 may repeatedly sense current at the daisy chain outlet (in block 1210), compare the sensed current to the delay current threshold, and determine whether to delay charging in response to determining that the current is above the delay current threshold (block 1215) or to initiate charging in response to determining that the current is below the delay current threshold (block 1220). Accordingly, in some examples, the sensing, in block 1210, may include the charger controller determining that the current at the daisy chain outlet is at a first current level at a first moment in time (e.g., in a first pass through the process 1200), wherein the first current level is above the delay current threshold, and determining that the current at the daisy chain outlet is at a second current level at a second moment of time subsequent to the first moment in time (e.g., in a later pass through the process 1200), wherein the second current level is below the delay current threshold. On the first pass, based on the first current, the charger controller 1102 may delay charging in response to determining that the current is above the delay current threshold (block 1215), and on the later pass, the charger controller 1102 may initiate charging in response to determining that the current is below the delay current threshold (block 1220).

Accordingly, the battery charger 1100 may self-regulate to ensure that the battery charger 1100 does not begin charging until downstream battery chargers (coupled via the daisy chain outlet 1110) have completed charging or are drawing low enough current such that charging, by the battery charger 1100, will not exceed a current limit for the power network 225 to which the battery charger 1100 is coupled. In some examples, the battery charger 1100 is one of a plurality of battery chargers 1100 daisy-chained together, as illustrated and discussed with respect to FIGS. 10A-10C. Accordingly, each respective battery charger 1100 self-regulates. As a result, (upstream) battery chargers closer to the outlet 240 have a lower priority and (downstream) battery chargers farther from the outlet 240 (having more intervening chargers between itself and the outlet 240) have a higher priority. Accordingly, the higher priority (downstream) chargers can charge their battery pack(s) 530 before the lower priority (upstream) chargers.

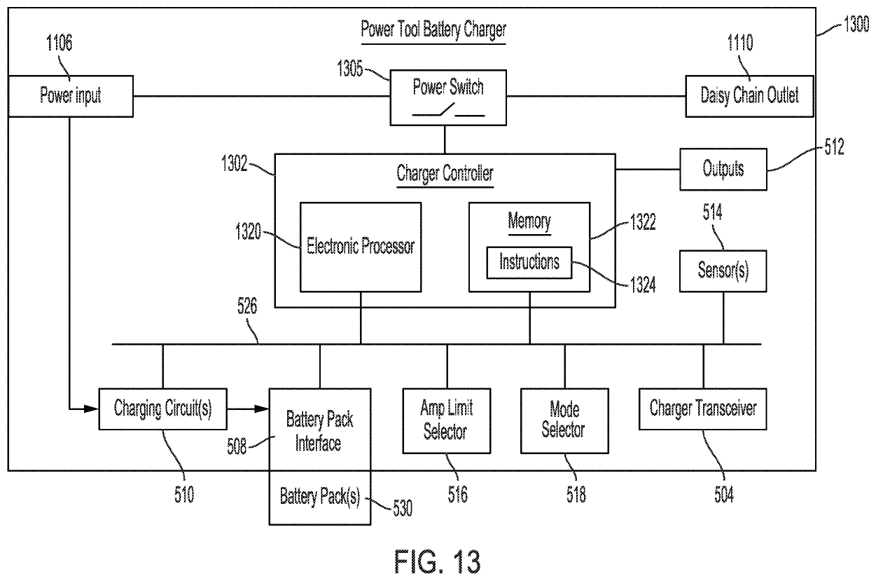

FIG. 13 is a block diagram of a power tool battery charger 1300, according to some examples. The power tool battery charger 1300 (also referred to as the battery charger 1300) is an example of a battery charger 1010 (FIG. 10A), a battery charger 1040 (FIG. 10B), and a battery charger 1065 (FIG. 10D) included in a charging systems 1000a, 1000b, and 1000c, respectively.

The battery charger 1300 has several similar components as the battery charger 500 of FIGS. 5 and 1100 of FIG. 11. More particularly, components of the battery charger 1300 having like number with the battery charger 500 or 1100 are similar and the discussion above with respect to the components of the battery charger 500 or 1100 similarly applies to the like numbered components of the battery charger 1300, except for any differences noted herein. Additionally, the battery charger 1300 includes a charger controller 1302 including an electronic processor 1320 and a memory 1322 storing instructions 1324, which are generally and structurally similar to, respectively, the charger controller 502, the electronic processor 520, the memory 522 storing instructions 524. Accordingly, the discussion above with respect to these corresponding components of the battery charger 500 similarly applies to the like named components of the battery charger 1300, except for any differences noted herein. For example, the instructions 1324 may be revised, relative to the instructions 524, to account for the varied functionality of the charger 1300 relative to the charger 500 discussed herein.

The battery charger 1300 may further include a power switch 1305. The power switch may be a relay, a field effect transistor, or another power switching element. The power switch 1305 may be coupled electrically between the power input 1106 and the daisy chain outlet 1110. The power switch 1305 may be controlled by the charger controller 1302 to open, to stop or prevent flow of power from the power input 1106 to the daisy chain outlet 1110, or to close, to permit flow of power from the power input 1106 to the daisy chain outlet 1110. Further, in some examples, the battery charger 1300 may not communicate with a charger coordination controller 105, in contrast to the charger 500. The charger transceiver 504, however, may be used by the charger controller 1302 to communicate with other computing devices for other purposes (e.g., configuration of the battery charger 1300, exporting battery information, etc.). In some examples, the outputs 512 include a light emitting diode (LED) indicator proximate to the daisy chain outlet 1110 to indicate whether the daisy-chain outlet is enabled (i.e., whether the switch 1305 is closed) and whether the daisy-chain outlet is disabled (i.e., whether the switch 1305 is open).

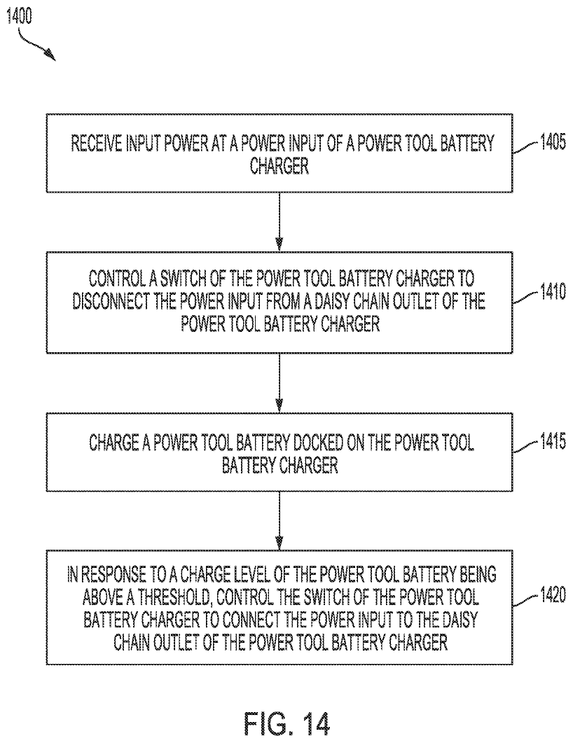

FIG. 14 a flowchart illustrating a process 1400 of charging power tool battery packs according to some examples. Process 1400 can be executed by the charger 1300 and, more particularly, by the charger controller 1302 of the battery charger 1300 of FIG. 13, for example, as described with respect to one or more of the charging systems 1000a, 1000b, and 1000c. One or more algorithms for performing process 1400 can be stored in instructions 1324 in memory 1322, and executed by electronic processor 1320, for example. Although the blocks of process 1400 are illustrated in a particular order, one or more of the blocks may be executed in another order or in parallel (partially or entirely) with another block or blocks of the process 1400. Although the process 1400 is described with respect to the charger controller 1302 and systems 1000a, 1000b, and 1000c, in some examples, the process 1400 is executed by another device or within another system.

At block 1405, a power input of a power tool battery charger receives input power. For example, the battery charger 1300 receives input power at the power input 1106. The input power may be received from a power supply 220 via a power network 225, or from daisy chain outlet of another instance of the battery charger 1100 (an upstream charger).

At block 1410, a charger controller of the battery charger controls a switch of the power tool battery charger to disconnect the power input from a daisy chain outlet of the power tool battery charger. For example, the charger controller 1302 may control the switch 1305 to disconnect the power input 1106 from the daisy chain outlet 1110. In some examples, the charger controller 1302 controls the switch to disconnect the power input from the daisy chain outlet in response to determining that the charge level of the power tool battery 530 docked on the charger 1300 is below the threshold.

At block 1415, the battery charger charges a power tool battery docked on the power tool battery charger. For example, the charger controller 1302 of the battery charger 1300 may transmit a command the charging circuits 510 of the battery charger 1300 to charge the battery pack(s) 530 coupled to the battery pack interface 508.

At block 1420, in response to a charge level of the power tool battery being above a threshold, the charger controller controls the switch of the power tool battery charger to connect the power input to the daisy chain outlet of the power tool battery charger to supply output power at the daisy chain outlet. For example, the charger controller 1302 may sense a charge level (e.g., a state of charge) of the power tool battery 530 coupled to the battery pack interface 508. To sense the charge level, the charger controller 1302, via a voltage sensor of the sensors 514, may measure a voltage across terminals of the battery pack 530. The measured voltage can correspond to a charge level of the battery pack 530. The charger controller 1302 may then compare the charge level of the battery pack 530 to a threshold, which may be a charge level threshold. In some examples, the charge level threshold is set to a level to indicate that the battery pack 530 is fully charged. In another example, the charge level threshold is set to a level to indicate that the battery pack 530 is nearly charged (e.g., at 75%, 80%, or 85% charge level). In some examples, the charger 1300 may include a selector to indicate the charge level threshold to the charger controller 1302. For example, the selector may be switch, dial, or button that selects between different charge level thresholds, such as, for example, between a first charge level threshold (e.g., of 75, 80%, or 85%) and a second charge level threshold (e.g., of 95% or 100%).

In some examples, the process blocks 1410, 1415, and 1420 may be looped or repeated periodically or continuously while input power is received at the power input (in block 1405). In such examples, the charger controller 1302 may maintain the switch in an open state (block 1410) and charge the battery pack (block 1415), while repeatedly sensing the charge level of the docketed battery pack(s) 530 for comparing to the threshold. Then, when the charge level is eventually determined to be above the threshold, the charger controller 1302 may control the switch to a closed state to connect the power input to the daisy chain outlet (block 1420).

Accordingly, the battery charger 1300 may self-regulate to ensure downstream battery chargers (coupled via the daisy chain outlet 1110) do not start charging until the battery charger 1300 has completed charging or is drawing low enough current such that charging, by the downstream chargers, will not exceed a current limit for the power network 225 to which the battery charger 1300 is coupled. In some examples, the battery charger 1300 is one of a plurality of battery chargers 1300 daisy-chained together, as illustrated and discussed with respect to FIGS. 10A-10C. Accordingly, each respective battery charger 1300 self-regulates in a similar manner as described. As a result, (upstream) battery chargers closer to the outlet 240 have a higher priority and (downstream) battery chargers farther from the outlet 240 (having more intervening chargers between itself and the outlet 240) have a lower priority. Accordingly, the higher priority (upstream) chargers can charge their battery pack(s) 530 before the lower priority (downstream) chargers.

As noted, in some examples, charge level threshold is set to a level to indicate that the battery pack 530 is nearly charged (e.g., at 75%, 80%, or 85% charge level), but not fully charged. In such examples, the battery charger 1300 may further include a current sensor, similar to current sensor 1112 of FIG. 11, to monitor current at the daisy chain outlet 1110. Further, process 1400 may include an additional block subsequent to block 1420 in which the charger controller 1302 determines, via the current sensor, whether the current at the daisy chain outlet 1110 is below a current threshold. When the current is below the threshold, the charger controller 1302 may again initiate charging of the battery pack(s) 530 to completely charge or “top-off” the battery pack(s) 530. Accordingly, the plurality of battery chargers 1300 daisy-chained together may collectively charge their respective battery packs 530 to an initial charge level (e.g., of 75%, 80%, or 85%), at which point, the battery chargers 1300 may then return to completely charge the battery packs 530.

The disclosure is not limited in its application to the details of construction and the arrangement of components set forth in the following description or illustrated in the following drawings. The disclosed systems and methods are capable of being implemented in varied embodiments and of being practiced or of being carried out in various ways. Also, the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature can sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components can be consolidated and performed by a single component. Similarly, the functions described herein as being performed by one component can be performed by multiple components in a distributed manner. Additionally, a component described as performing particular functionality can also perform additional functionality not described herein. For example, a device or structure that is “configured” in a certain way is configured in at least that way, but can also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications can be made to these configurations without departing from the scope or spirit of the claimed subject matter.

Certain operations of methods according to the disclosure, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” etc. are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, the phase “and/or” used with two or more items is intended to cover the items individually and the items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A system for charging power tool battery packs, the system comprising:
a charger coordination controller including an electronic processor and a wireless transceiver, the charger coordination controller configured to:
receive, via the wireless transceiver, charger information from a plurality of power tool battery charger systems;
determine a charger subset of the plurality of power tool battery charger systems to be enabled based on the charger information, the charger subset including at least a first power tool battery charger system of the power tool battery charger systems; and
transmit, via the wireless transceiver, a charger enabling instruction to the charger subset.

2. The system of claim 1, wherein the charger coordination controller is integrated into a second power tool battery charger system of the plurality of power tool battery charger systems.

3. The system of claim 1, wherein the charger coordination controller is housed in a standalone housing external to the plurality of power tool battery charger systems.

4. The system of claim 3, wherein the standalone housing includes an electro-mechanical interface including power terminals, the electro-mechanical interface configured to
engage a battery receptacle of a further power tool battery charger or a power tool battery pack, and
receive power from the further power tool battery charger or the power tool battery pack to power the electronic processor and the wireless transceiver.

5. The system of claim 1,
wherein the plurality of power tool battery charger systems each include a charger wireless transceiver and form a star communication network with the electronic processor via the wireless transceiver, and
wherein, to receive, via the wireless transceiver, the charger information from the plurality of power tool battery charger systems, the charger coordination controller is configured to:
receive the charger information via the star communication network, wherein the charger information for the first power tool battery charger system is received directly from the first power tool battery charger system.

6. The system of claim 1,
wherein the plurality of power tool battery charger systems each include a charger wireless transceiver and form a mesh communication network, and
wherein, to receive, via the wireless transceiver, the charger information from the plurality of power tool battery charger systems, the charger coordination controller is configured to:
receive the charger information via the mesh communication network, wherein the charger information for the first power tool battery charger system is received via a second power tool battery charger system of the plurality of power tool battery charger systems.

7. The system of claim 1, wherein the charger information includes one or more of: a charger identifier, a battery pack identifier, a charger ready indication, a battery pack docked indication, or expected current draw based on a docked battery pack.

8. The system of claim 1, wherein the charger subset includes one or more additional power tool battery charger systems of the plurality of power tool battery charger systems.

9. The system of claim 1, wherein the first power tool battery charger system includes a power tool battery charger and a wireless outlet controller,
wherein the wireless outlet controller is configured to:
receiving, by a plug receptacle interface of the wireless outlet controller, a power plug of the power tool battery charger,
receiving, via a plug of the wireless outlet controller, power from an AC source,
receiving, via a charger wireless transceiver of the wireless outlet controller, the charger enabling instruction, and
control, in response to the charger enabling instruction, a power switch of the wireless outlet controller to provide the power from the AC source to the power plug of the power tool battery charger; and
wherein the power tool battery charger is configured to:
charge a power tool battery pack using the power from the AC source.

10. The system of claim 1, wherein the charger coordination controller is further configured to:
receive, via the wireless transceiver, further charger information from the charger subset indicating a charging progress of the charger subset;
determine a second charger subset of the plurality of power tool battery charger systems to be enabled based on the charger information and the further charger information, the second charger subset including at least a second power tool battery charger system of the power tool battery charger systems; and
transmit, via the wireless transceiver, a second charger enabling instruction to the second charger subset.

11. A method of charging power tool battery packs, the method comprising:
receiving, by an electronic processor via a wireless transceiver, charger information from a plurality of power tool battery charger systems;
determining, by the electronic processor, a charger subset of the plurality of power tool battery charger systems to be enabled based on the charger information, the charger subset including at least a first power tool battery charger system of the power tool battery charger systems; and
transmitting, by the electronic processor via the wireless transceiver, a charger enabling instruction to the charger subset.

12. The method of claim 11, wherein the electronic processor and wireless transceiver are integrated into a second power tool battery charger system of the plurality of power tool battery charger systems.

13. The method of claim 11, wherein the electronic processor and wireless transceiver are housed in a standalone housing external to the plurality of power tool battery charger systems.

14. The method of claim 13, wherein the standalone housing includes an electro-mechanical interface including power terminals, the method further comprising:
engaging, by the electro-mechanical interface, a battery receptacle of a further power tool battery charger or a power tool battery pack; and
receiving, via the electro-mechanical interface, power from the further power tool battery charger or the power tool battery pack to power the electronic processor and the wireless transceiver.

15. The method of claim 11,
wherein the plurality of power tool battery charger systems each include a charger wireless transceiver and form a star communication network with the electronic processor via the wireless transceiver, and
wherein receiving, by the electronic processor via the wireless transceiver, the charger information from the plurality of power tool battery charger systems comprises:
receiving the charger information via the star communication network, wherein the charger information for the first power tool battery charger system is received directly from the first power tool battery charger system.

16. The method of claim 11,
wherein the plurality of power tool battery charger systems each include a charger wireless transceiver and form a mesh communication network, and
wherein receiving, by the electronic processor via the wireless transceiver, the charger information from the plurality of power tool battery charger systems comprises:
receiving the charger information via the mesh communication network, wherein the charger information for the first power tool battery charger system is received via a second power tool battery charger system of the plurality of power tool battery charger systems.

17. The method of claim 11, wherein the charger information includes one or more of: a charger identifier, a battery pack identifier, a charger ready indication, a battery pack docked indication, or expected current draw based on a docked battery pack.

18. The method of claim 11, wherein the charger subset includes one or more additional power tool battery charger systems of the plurality of power tool battery charger systems.

19. The method of claim 11, wherein the first power tool battery charger system includes a power tool battery charger and a wireless outlet controller, the method further comprising:
receiving, by a plug receptacle interface of the wireless outlet controller, a power plug of the power tool battery charger;
receiving, via a plug of the wireless outlet controller, power from an AC source;
receiving, via a charger wireless transceiver of the wireless outlet controller, the charger enabling instruction;
controlling, in response to the charger enabling instruction, a power switch to provide the power from the AC source to the power plug of the power tool battery charger; and
charging, by the power tool battery charger, a power tool battery pack using the power from the AC source.

20. The method of claim 11, further comprising:
receiving, by the electronic processor via the wireless transceiver, further charger information from the charger subset indicating a charging progress of the charger subset;
determining, by the electronic processor, a second charger subset of the plurality of power tool battery charger systems to be enabled based on the charger information and the further charger information, the second charger subset including at least a second power tool battery charger system of the power tool battery charger systems; and
transmitting, by the electronic processor via the wireless transceiver, a second charger enabling instruction to the second charger subset.

21.-40. (canceled)
